(19) United States
(12) Patent Application Publication
(10) Pub. No.: US 2009/0216537 A1
(43) Pub. Date: Aug. 27, 2009

(54) SPEECH SYNTHESIS APPARATUS AND METHOD THEREOF

(75) Inventors: Osamu Nishiyama, Kanagawa (JP); Masahiro Morita, Kanagawa (JP); Takehiko Kagoshima, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Minato-ku, Tokyo (JP)

(21) Appl. No.: 11/570,208

(22) PCT Filed: Oct. 19, 2006
(86) PCT No.: PCT/JP2006/321579

§ 371 Date: Apr. 30, 2009

(30) Foreign Application Priority Data
Mar. 29, 2006 (JP) 2006-092489

(51) Int. Cl. G10L 13/06

(52) U.S. Cl. 704/267; 704/E13.002

(57) ABSTRACT

A speech synthesis apparatus includes a text obtaining device that obtains text data for speech synthesis from the outside, a language processor that carries out morphological analysis/parsing to the text data, a prosodic processor that outputs, to a speech synthesizer, a synthesis unit string based on the prosodic and language related attributes of the text data such as accents and word classes, the speech synthesizer that generates synthesized speech from the synthesis unit string, and a speech waveform output device that reproduces a prescribed amount of output synthesized speech after it is accumulated or sequentially as it is output.

### CROSS-REFERENCE TO RELATED APPLICATIONS

This application is based upon and claims the benefit of priority from the prior Japanese Patent Application No. 2006-92489, filed on May 29, 2006, the entire contents of which are incorporated herein by reference.

### TECHNICAL FIELD

The present invention relates to a speech synthesis apparatus, a speech synthesis method, and a speech synthesis program that allow speech to be synthesized based on phonological symbols such as phonemic symbols/syllabic symbols or a series of characters for use in natural language representation.

### BACKGROUND OF THE INVENTION

As described in Proceedings of 2004 Autumn Meeting of the Acoustic Society of Japan, pp. 369 to 370, it has been known that to increase available waveform data is effective as a method of improving the sound quality with a conventional speech synthesizer. A proposed approach to carry out this method is to distribute a large amount of waveform data between a memory and a hard disk and use it.

According to the disclosure of Japanese Patent Application Kokai No. 07-141000, in a speech synthesis apparatus that produces synthesized speech for each synthesis unit string (processing unit) made of a combination of a plurality of synthesis units, when a large amount of waveform data is distributed between a memory and a hard disk, more frequently used waveform data is provided with priority in a memory that allows data to be obtained at high speed.

Japanese Patent Application Kokai No. 2005-266010 discloses a method of sequentially determining synthesis fragments from the beginning based on a plurality of sub costs including a cost related to the access speed (access speed cost) to a storing device that stores the waveform data of the synthesis fragments (referred to as “speech fragments” in the disclosure of Japanese Patent Application Kokai No. 07-14100).

According to the methods disclosed by Japanese Patent Application Kokai Nos. 07-141000 and 2005-266010, the total processing time necessary for producing synthesized speech corresponding to a plurality of processing units can be reduced to some extent if not with exact reliability.

When however synthesized speech corresponding to a certain processing unit among these plurality of processing units is produced, waveform data provided in the hard disk that allows data to be obtained only at low speed may intensively be used. In this case, the time required for obtaining the waveform data from the hard disk occupies an excessive percentage in the time required for producing the synthesized speech corresponding to the processing unit, which may cause the processing unit time to greatly vary among the processing units. However, there is neither a method to avoid this variation nor a method to surely prevent increase in the time required for producing synthesized speech caused by the data obtaining operation.

As in the foregoing, according to the conventional technique, there is large difference among the processing units in the time required for producing synthetic speech. The increase in the time required for producing the synthetic speech caused by the data obtaining operation cannot surely be reduced.

The present invention is therefore directed to a solution to the above described problems, and it is an object of the invention to provide a speech synthesizer, a speech synthesis method, and a speech synthesis program that allow increase in time for producing synthesized speech caused by data obtaining operation to be surely prevented without generating large difference among processing units in the time required for producing synthesized speech.

### DISCLOSURE OF INVENTION

According to embodiments of the present invention, a speech synthesizer obtains waveform data of synthesis fragments corresponding to a plurality of synthesis units in a prescribed processing unit included in an input synthesis unit string and synthesizes speech by connecting the waveform data, and the speech synthesizer includes an attribute information storage medium that stores the attribute information of said synthesis fragments other than the waveform data, a plurality of waveform data storage mediums that store the waveform data of said synthesis fragments having different data obtaining time for obtaining said stored waveform data, a data positional information storage medium that stores data positional information including the identifier of a waveform data storage medium that stores said waveform data for each said synthesis fragment, a candidate obtaining unit that obtains a synthesis fragment candidate corresponding to each said synthesis unit from said attribute information storing mediums based on the attribute information of each said synthesis unit in said processing unit, a synthesis fragment selector that obtains a plurality of series each including a combination of a plurality of synthesis fragment candidates obtained for each said synthesis unit and selects one series from said plurality of series based on said data positional information so that the total time required for obtaining the waveform data of said synthesis fragments in said processing unit does not exceed the upper limit for data obtaining time, a synthesis fragment producing unit that combines synthesis fragments on said selected one series to produce a synthesis fragment string, and a waveform generator that obtains the waveform data of the synthesis fragments included in said synthesis fragment string from each said waveform data storage medium and connects the data.

According to the invention, no large difference is generated between processing units in the time required for producing synthesized speech, and increase in the time required for producing synthesized speech caused by the data obtaining operation can surely be reduced.

### BRIEF DESCRIPTION OF DRAWINGS

FIG. 1 is a block diagram of the configuration of a speech synthesizer according to a first embodiment of the invention;

FIG. 2 is a block diagram of the configuration of a speech synthesizer 14 in the speech synthesis apparatus according to the first embodiment;

FIG. 3 is a flowchart for illustrating the operation of the speech synthesis apparatus according to the first embodiment;

FIG. 4 is a flowchart for illustrating the operation of the speech synthesizer 14 in the speech synthesis apparatus according to the first embodiment;

FIG. 5 is a diagram for illustrating preliminary selection;

FIG. 6A is a diagram for illustrating processing when a condition related to obtaining data is not fulfilled;

FIG. 6B is a table of an example of the internal structure of data positional information (related to waveform data);

FIGS. 7A and 7B are diagrams for illustrating connection cost calculation;

FIG. 8 is a diagram for illustrating total cost calculation;

FIG. 9 is a diagram for illustrating a condition for obtaining data (Best Path calculation 1 in each access rank);

FIG. 10 is a diagram for illustrating a condition for obtaining data (Best Path calculation 2 in each access rank);

FIG. 11 is a diagram for illustrating a condition for obtaining data (Best Path calculation 3 in each access rank);

FIG. 12 is a diagram for illustrating the manner of storing paths and total costs for Best Paths in all access ranks;

FIG. 13 is a diagram for illustrating a condition for obtaining data (a result when application to a processing unit is completed);

FIG. 14 is a diagram for illustrating a condition for obtaining data (Best Path in a processing unit);

FIG. 15 is a block diagram of the configuration of a speech synthesizer showing the general structure of a second embodiment of the invention;

FIG. 16 is a block diagram of the configuration of a speech synthesizer 17 in the speech synthesis apparatus according to the second embodiment;

FIG. 17 is a flowchart for illustrating the operation of the speech synthesizer 17 in the speech synthesis apparatus according to the second embodiment;

FIG. 18A is a diagram for illustrating processing when a condition related to obtaining data is not fulfilled;

FIG. 18B is a table of an example of the internal structure of data positional information (related to waveform data);

FIG. 19 is a diagram for illustrating a condition for obtaining data (Best Path selection 1 in each access rank);

FIG. 20 is a diagram for illustrating a condition for obtaining data (Best Path selection 2 in each access rank);

FIG. 21 shows a Best Path in all the ranks;

FIG. 22 is a diagram for illustrating a condition for obtaining data (when application of a condition for obtaining data at a processing unit is complete); and

FIG. 23 is a diagram showing how a condition for obtaining data is applied to the intervals between a plurality of synthesis units.

### BEST MODE FOR CARRYING OUT THE INVENTION

### Definitions of Terms

Before embodiments of the invention are described, terms to be used herein will be defined.

The term “synthesis unit” refers to a basic element that constitutes synthesized speech or speech uttered by a person, and the kind of unit used when a plurality of waveform data groups sharing a certain common characteristic are formed. In a conventional example, there are a half-phoneme, a phoneme, a syllable, a diphone, a CVC, a VCV and the like (in which C represents a consonant and V represents a vowel).

The term “synthesis unit string” is a series of a plurality of synthesis units.

The term “processing unit” refers to a series of a plurality of synthesis units that satisfy a prescribed condition.

The “condition” includes for example the number or the sum of duration lengths of segments corresponding to the synthesis units of a target synthesized speech.

The term “phonological symbol” corresponds to a label provided to each categorized set based on a certain synthesis unit. When for example the synthesis unit is a phoneme, a phonemic symbol corresponds to the phonological symbol. In a conventional example, there are phonemic symbols, speech symbols, and syllabic symbols, and combinations thereof.

The term “synthesis fragment” refers to an element that belongs to any of categorized sets based on a certain synthesis unit. When for example a phoneme is a synthesis unit, only waveform data sharing a prescribed common characteristic belongs to a set of waveform data for a segment of recorded speech provided with the same phonemic symbol. One synthesis fragment is completed by providing these kinds of waveform data with attributes other than the waveform data such as a language related attribute in the segment of the utterance in the natural language (such as the distance from an accent nucleus, the word class of a word including the segment), values (attribute values) related to the acoustic attributes of the segment of the uttered speech (such as the basic frequency).

The term “fragment attribute” refers to any of the attributes of a synthesis fragment other than the waveform data. The fragment attributes include for example the above described language related attributes (language attributes) and acoustic attributes.

The term “fragment data” collectively represents values for the attributes of a synthesis fragment. The term collectively represents the waveform data of each synthesis fragment, the data of the fragment attribute “basic frequency,” and the like.

The term “fragment ID” is an identifier assigned to each synthesis fragment in order to identify itself from the others.

Now, embodiments of the invention will be described using the terms with reference to the accompanying drawings.

### FIRST EMBODIMENT

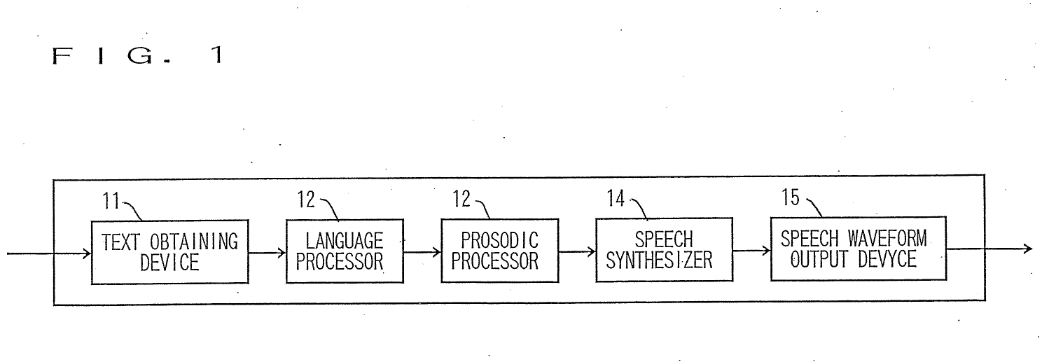

Now, a speech synthesis apparatus according to a first embodiment of the invention will be described with reference to FIGS. 1 to 14.

(1) Configuration of Speech Synthesis apparatus

FIG. 1 is a block diagram of the configuration of the speech synthesis apparatus 10 according to the embodiment.

The speech synthesis apparatus 10 includes a text obtaining device 11 that obtains text data for speech synthesis from the outside, a language processor 12 that carries out morphological analysis/parsing to the text data, a prosodic processor 13 that outputs, to a speech synthesizer 14, a synthesis unit string based on the prosodic and language related attributes of the text data such as accents and word classes, the speech synthesizer 14 that produces synthesized speech from the synthesis unit string, and a speech waveform output device 15 that reproduces a prescribed amount of output synthesized speech after it is accumulated or sequentially as it is output.

The speech synthesis apparatus 10 may be implemented by pre-installing a program in a computer that enables the computer to implement the functions of the units 11 to 14 or by storing the program in a storage medium such as a CD-ROM or distributing the program through a network, so that the program is installed in the computer as required. The storage medium that stores speech fragment data may be implemented as required by a memory or a hard disk provided inside or outside the computer, or using a CD-R, a CD-RW, a DVD-RAM, a DVD-R and the like.

Note that the “synthesis units” that constitute the synthesis unit string to be transmitted to the speech synthesizer 14 from the prosodic processor 13 are provided with language information related to text including segments to which phonemic symbols or target prosodic information correspond. Target synthesized speech is expressed by the synthesis unit string, and the result is transmitted to the speech synthesizer 14.

The “prosodic information” includes information such as basic frequency, duration, mel cepstrum, and power.

The “language information” includes information such as words, the number of syllables in an accented phrase or the number of moras/accent types, words corresponding to each synthesis unit, positions based on syllables in an accented phrase or moras, and a flag indicating whether or not a syllable including each synthesis unit is an accent nucleus.

(2) Configuration of Speech Synthesizer 14

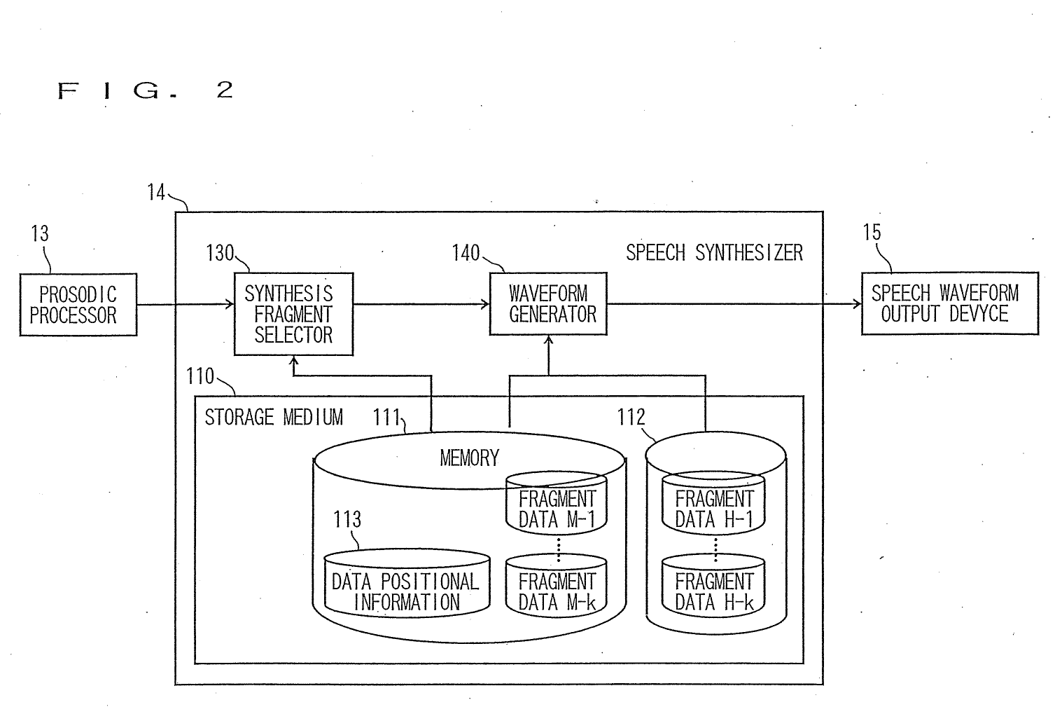

Now, the speech synthesizer 14 will be described with reference to FIG. 2. FIG. 2 is a block diagram of the speech synthesizer 14.

The speech synthesizer 14 includes a storage medium 110, a synthesis fragment selector 130, and a waveform generator 140.

The storage medium 110 includes a plurality of storage mediums that store all the fragment data of all synthesis fragments (M−1, . . . , M−k, H−1, . . . , H−k) and the mediums vary in the data obtaining time. More specifically, the medium includes a memory 111 and a hard disk (hereinafter referred to as “HDD”) 112. The memory 111 stores fragment data related to all the fragment attributes of all the synthesis fragments, all the waveform data of a part of the synthesis fragments, and data positional information 113 that records whether the memory 111 or the HDD 112 stores the waveform data of all the synthesis fragments. The HDD 112 stores the waveform data of the synthesis fragments that are not stored by the memory 111.

The synthesis fragment selector 130 selects synthesis fragments for each synthesis unit and produces a synthesis fragment string made of a combination of a plurality of synthesis fragments based on the phonological/prosodic information/language information of target synthesized speech included in each synthesis unit in a synthesis unit string input from the prosodic control unit 13, the fragment data of a prescribed fragment attribute of each synthesis fragment stored in the memory 111, the data positional information 113, and a condition for the synthesis unit string related to obtaining the waveform data from the HDD 112.

The waveform generator 140 obtains the waveform data of synthesis fragments selected for each of the synthesis units from the memory 111 and the HDD 112 and connects the data to produce synthesized speed corresponding to the synthesis unit string.

Note that the “waveform data” according to the embodiment may be a series of parameters produced by encoding waveform data or may include the “waveform data” as well as data for use in the waveform generator 140 such as pitch marks instead of the described example.

In the described embodiment, the “waveform data” is an example of the fragment data recorded in the data positional information 113 but the data may be other kinds of data as long as it is waveform data to be used in processing in the succeeding stage of the synthesis fragment selector 130 or fragment data related to a prescribed fragment attribute and not stored in a single storage medium for all synthesis fragments (distributed among a plurality of storage mediums) instead of the above described example.

In the description, the information related to “all the synthesis fragments” is recorded as an example of information recorded in the data positional information 113, but it is only necessary that eventually the storage medium that stores fragment data related to the waveform data of all the synthesis fragments can uniquely be determined. For example, a storage medium that stores prescribed fragment data of a certain synthesis fragment may be determined based on its absence in the data positional information 113 instead of the described manner.

Note that the speech synthesizer 14 may be implemented for example by a general-purpose computer as basic hardware.

More specifically, the attribute information storage mediums/waveform data storage mediums that store fragment data of synthesis fragments and have different data obtaining time, the synthesis fragment selector 130 that produces a synthesis fragment string made of a combination of a plurality of synthesis fragments at least based on data positional information that records the storage medium that stores the waveform data of the synthesis fragments, conditions for a synthesis unit string related to obtaining the waveform data from each of the waveform data storage mediums and the data positional information, and the waveform generator 140 that obtains the waveform data of the synthesis fragments in the synthesis fragment string and connect the data can be implemented by enabling a processor provided in the computer to carry out the program.

(3) Configuration of Storage Medium 110

In the description of the embodiment, with reference to the structure of a general computer as an example, the storage medium 110 includes a combination of a memory 111 as a main storage device and an HDD (also referred to as “HD” and “hard disk”) 112 as an auxiliary storage device.

Note however that other than the device structure according to the embodiment, an external storage device (removable disk) may be incorporated. A magnetic disk such as a removable hard disk, an optical disk such as a CD and a DVD, semiconductor memories such as various flash memories (such as NAND type, NOR type, DiNOR type, and ORNAND type devices) may be additionally provided, and a plurality of storage mediums may be used from the main storage device, the auxiliary storage device, and the external storage device.

Instead of the auxiliary storage device, an external storage device may be used, and a plurality of storage mediums may be used from the main storage device and the external storage device.

In this way, as long as a plurality of storage mediums having different data obtaining time are used, any combination may be employed other than the example described above.

(4) Operation of Speech Synthesis apparatus 10

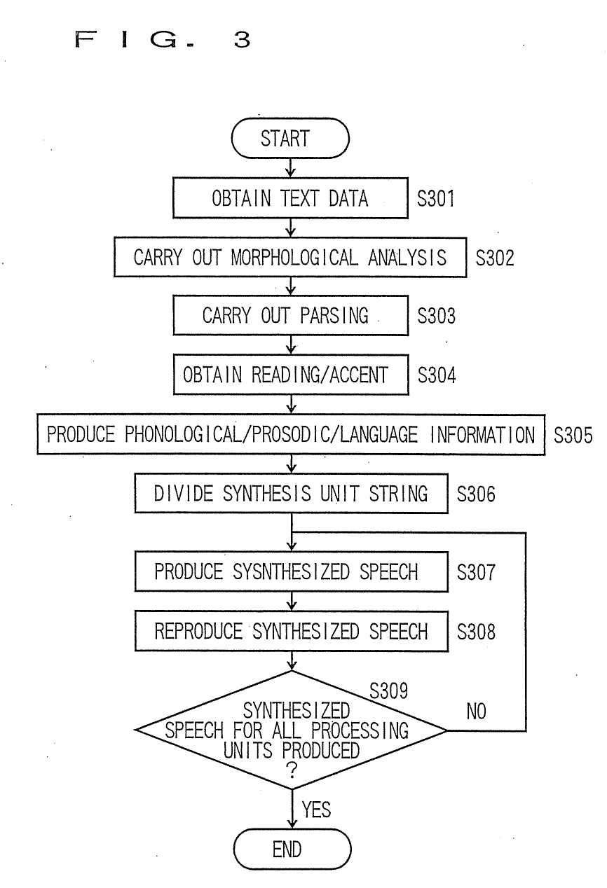

Now, with reference to FIGS. 1 and 3, the operation of the speech synthesis apparatus 10 according to the embodiment will be described. FIG. 3 is a flowchart for illustrating the operation of the speech synthesis apparatus 10.

The text obtaining device 11 obtains text data for speech synthesis from the outside (S301).

The language processor 12 carries out morphological analysis to the text data obtained by the text obtaining device 11 and divides data into morphemes (S302). Note that in languages other than an agglutinative language, the step is omitted in some cases.

The language processor 12 carries out parsing to a series of morphemes produced by dividing, and provides the morphemes with attribute values for example about read information, class kind, conjugation, and dependency between morphemes (S303).

Then, the prosodic processor 13 additionally provides prosody related attribute values such as a prosodic symbol string and an accent type to the morphemes in the series of morphemes provided with values related to prescribed attributes input from the language processor 12 based on the attribute values (S304).

The prosodic processor 13 produces target prosodic information for synthesized speech based on the attribute values provided to the morphemes in S303 and S304 on the basis of a synthesis unit and produces a synthesis unit string made of a plurality of synthesis units each having a phonological symbol, prosodic information, and language information (S305) According to the embodiment, a phoneme is a synthesis unit.

Then, the speech synthesizer 14 forms a plurality of synthesis unit strings made of a plurality of synthesis units that fulfill a prescribed condition (S306). According to the embodiment, division is carried out sequentially from the beginning so that the sum of the target duration lengths of synthesis units included in a processing unit is within a prescribed time period.

The speech synthesizer 14 produces synthesized speech corresponding to the processing unit at the beginning among the processing units for which corresponding speech is yet to be produced, and outputs the result to the speech waveform output device 15 (S307).

The step S307 will be detailed later.

The speech waveform output device 15 starts to reproduce the synthesized speech produced by the speech synthesizer 14, and the process immediately proceeds to S309.

The processing in S307 and S308 is repeated until the processing is carried out to all the processing units corresponding to the input text data (S309).

Note in S301 to S304, a database necessary for analysis or obtaining necessary data may be provided as desired.

In S305, a phoneme is a synthesis unit according to the embodiment though the synthesis unit is not limited to this.

In S306, according to the embodiment, a plurality of processing units are produced by dividing a synthesis unit string with reference to the sum of the duration lengths of synthesis units, but the string may be divided into processing units at intervals of a prescribed number of synthesis units sequentially from the beginning.

According to the embodiment, a plurality of processing units are formed based on the prescribed conditions in S306, while for example the synthesis unit string input from the prosodic processor 13 as a whole may be treated as one processing unit for the following processing such as when the synthesis unit string input from the prosodic processor 13 as a whole satisfies the prescribed condition. In this case, it is not necessary for the speech synthesizer 14 to select a processing unit in S307, and in S308 the speech waveform output device 15 does not have to proceed to S309, so that the processing in S309 is omitted.

(5) Operation of Speech Synthesizer 14

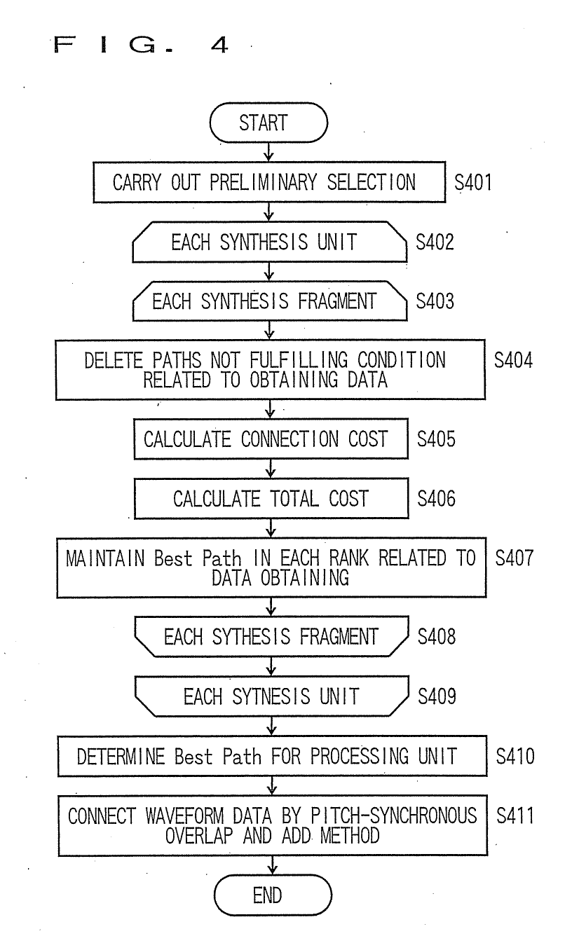

Now, with reference to FIGS. 2 and 4, the operation of the speech synthesizer 14 will be described. FIG. 4 is a flowchart for illustrating the operation of the speech synthesizer 14 to one processing unit.

(5-1) Preliminary Selection

The synthesis fragment selector 130 preliminarily selects a plurality of synthesis fragments for each of synthesis units included in the prescribed processing unit and narrows down the number of possible fragments. This is referred to as “preliminary selection” (S401). The preliminary selection includes two stages of selection, first preliminary selection and second preliminary selection.

(5-1-1) First preliminary Selection

In the first preliminary selection, a set of synthesis fragments provided with the same phonological symbol are selected in each synthesis unit. More specifically, a set of synthesis fragments are selected using the phonological symbol, and the selection range of synthesis fragments for use in producing a segment to which each synthesis unit of a target speech corresponds is limited. In this way, it is ensured that synthesis fragments having waveform data having a prescribed common character suitable for forming the segment are to be selected in the following processing.

(5-1-2) Second Preliminary Selection

In the second preliminary selection, the elements of the set of synthesis fragments selected in the first preliminary selection and provided with the same phonological symbol are compared to a synthesis unit provided with target prosodic information and language information in the following manner.

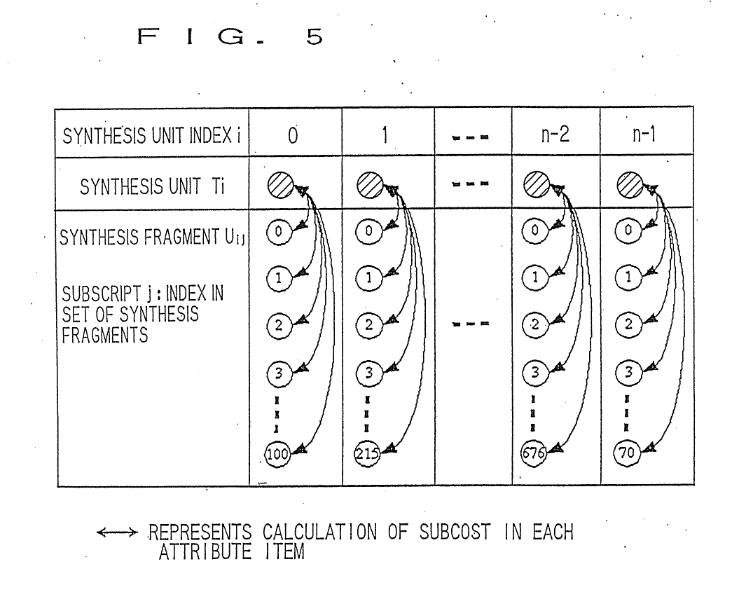

Regarding prescribed N_{K} attributes K, as shown in FIG. 5, the degree of the difference diff_{TARGET, K} (Tᵢ, Uᵢⱼ) between the target prosodic information of a synthesis unit Tᵢ (i=0, n−1) or language information Attrib_{K}(Tᵢ) and the attribute value Attrib_{K}(Uᵢⱼ) of each synthesis fragment Uᵢⱼ (j=0, Mᵢ−1) is calculated. The calculation is carried out using a target subcost function SubCost_{TARGET, K}(Attrib_{K}(Tᵢ), Attrib_{K}(Uᵢⱼ)) determined for each attribute K.

diff_{TARGET,K}(Tᵢ,Uᵢⱼ)=SubCost_{TARGET,K}(Attib_{K}(Tᵢ),Attrib_{K}(Uᵢⱼ))

Based on the weighted sum (weight WK (k=1, . . . , N_{K})) of the difference diff_{TARGET, K} (Tᵢ, Uᵢⱼ) between the target synthesis unit Tᵢ and each synthesis fragment Uᵢⱼ, the degree of difference DIFF_{TARGET} (Tᵢ, Uᵢⱼ) (target cost) between the synthesis unit Tᵢ related to each of these prescribed attributes and each synthesis fragment Uᵢⱼ is calculated.

$$\begin{matrix}{DIFF}_{TARGET} ( {T}_{i} , {U}_{ij} ) = {\sum }_{k = 1}^{{N}_{k}} \{ {w}_{k} \times {diff}_{TARGET , K} ( {T}_{i} , {U}_{ij} ) \} \\ = {\sum }_{k = 1}^{{N}_{k}} \{ \begin{matrix}{w}_{k} \times {SubCost}_{TARGET , K} \\ ( {Attrib}_{K} ( {T}_{i} ) , {Attrib}_{K} ( {U}_{ij} ) )\end{matrix} \}\end{matrix} \qquad ( 1 )$$

Thereafter, in the synthesis unit Tᵢ, prescribed M synthesis fragments are selected from Uᵢⱼ (j=0, . . . , Mᵢ₁) starting from the one having the smallest DIFF_{TARGET} (Tᵢ, Uᵢⱼ) which is the degree of the difference from the synthesis units as the elements of the target synthesized speech, and the U_{SELECTED, ij} (j=0, . . . , M−1) of the selected synthesis units Tᵢ will be subjected to further processing. The processing is carried out to all the synthesis units Tᵢ (i=0, . . . , n−1) in the processing unit.

According to the embodiment, the degree of difference DIFF_{TARGET} (Tᵢ, Uᵢⱼ) from synthesis fragments as the elements of the target synthesized speech is calculated using the weighted sum of the difference diff_{TARGET, K} (Tᵢ, Uᵢⱼ) related to each attribute K, while the product may be used for calculation instead of the described method.

Note that according to the embodiment, the upper limit for the number of synthesis fragments to select is not more than the prescribed number in each synthesis unit, while a threshold may be provided for the value of the degree of difference DIFF_{TARGET} (Tᵢ, Uᵢⱼ), so that synthesis fragments suitable for each synthesis unit may be selected by the processing using such a threshold instead of the described manner.

According to the embodiment, for the purpose of reducing the amount of succeeding processing, the upper limit for the number of synthesis fragments to preliminarily select is not more than the prescribed number in each synthesis unit, while such selection processing is not necessary if the succeeding processing can be carried out fast enough such as when the number of synthesis fragments is not more than the prescribed number.

(5-2) Determination of Synthesis Fragment Strings

Then, in S402 to S409, the synthesis fragment selector 130 carries out search for (hypothesizes and evaluates) paths (Path) that are each a series of synthesis fragments U_{SELECTED, ij} (j=0, . . . , M−1) preliminarily selected for each of the synthesis units Tᵢ (i=0, . . . , n−1) in S401 as nodes (Node) by Dynamic Programming (DP), and determines a plurality of synthesis fragment strings each having a plurality of synthesis fragments for the processing unit.

More specifically, it is assumed that for each of the synthesis fragments U_{SELECTED, ij}(j=0, . . . , M−1) selected by comparison with fragment unit Tᵢ, the synthesis fragment U_{SELECTED, ij} succeeds all the paths (a series of synthesis fragments) before the synthesis unit Tᵢ₋₁ connected to the synthesis fragment U_{SELECTED, (i-1)j}. These assumed paths (hypothesized paths) before Tᵢ are evaluated. Among the results, only the assumed paths having the highest Q evaluation results are selected, and information that can be used to uniquely specify the paths (the series of synthesis fragments) and the set of Q evaluation results are recorded in the synthesis fragment U_{SELECTED, ij}.

The series of processing is carried out to all the synthesis fragments U_{SELECTED, ij} (j=0, . . . , M−1) selected by comparison with the synthesis unit Tᵢ (from S403 to S408), and then after the completion, the process proceeds to the succeeding synthesis unit Tᵢ₊₁ and carries out the same operation (from S402 to S409).

(5-3) Processing from S404 to S407

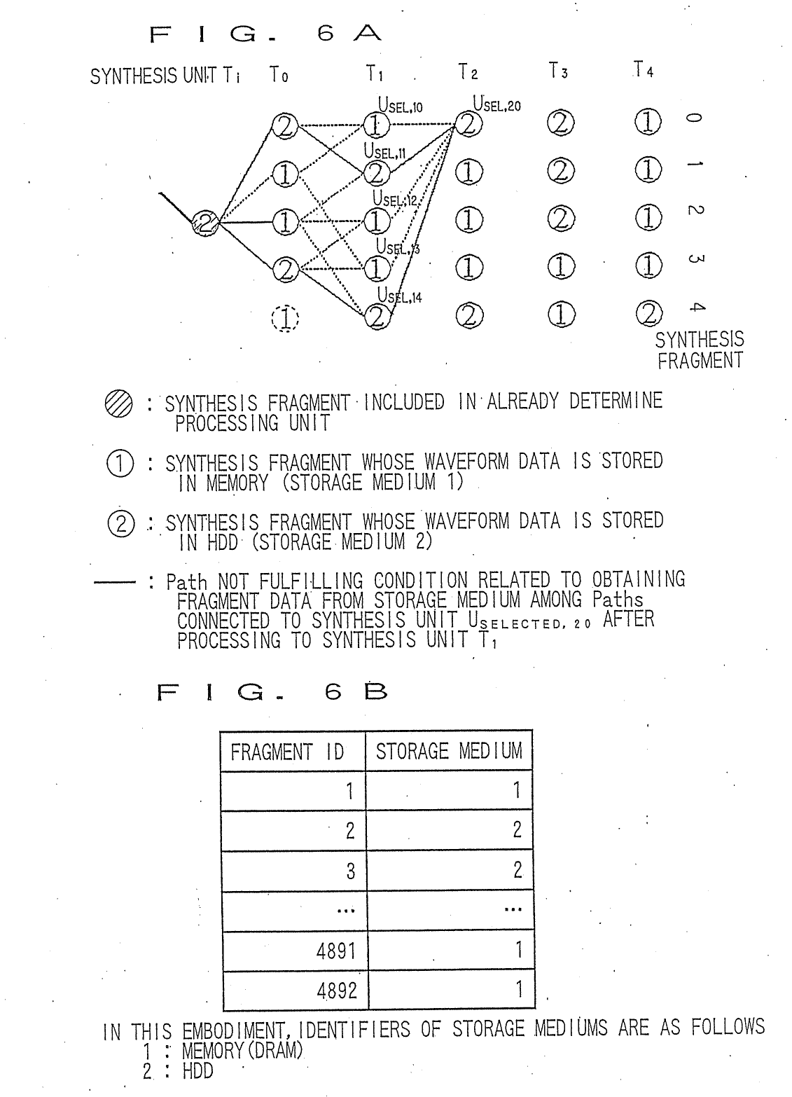

Now, the processing from S404 to S407 will be described with reference to FIGS. 6 to 10.

As shown in FIG. 6A, the synthesis fragment selector 130 assumes that all the paths (broken lines and bold solid lines) before T₁ connected to the synthesis fragment U_{SELECTED, ij} (j=0, . . . , 4) of the synthesis unit T₁ are connected with the synthesis fragment U_{SELECTED, 20} (the synthesis fragment of the synthesis unit T₂, j=0) (broken lines and bold solid lines). Paths ((U_{SELECTED, 00}, U_{SELECTED, 11}, U_{SELECTED, 20}), (U_{SELECTED, 03}, U_{SELECTED, 14}, U_{SELECTED, 20})) that do not fulfill the condition for obtaining the waveform data from the storage medium 110 for the synthesis unit string (processing units T₀ to T₄) are excluded from the assumed paths and from further evaluation (bold solid lines) (S404).

(5-3-1) Method of Applying Condition

A method of applying a condition for the synthesis unit string (processing unit) related to obtaining the waveform data from the storage medium 110 will be described.

According to the embodiment, as an example of a condition, the upper limit is set for how many times fragment data (waveform data) for use in processing in the succeeding stage of the synthesis fragment selector 130 can be obtained from the HDD 112 for each processing unit.

The data positional information 113 includes the fragment ID of each synthesis fragment and the identifier of each storage medium in association with each other for all the synthesis fragments so that which storage medium stores waveform data for use in the processing in the succeeding stage of the synthesis fragment selector 130 or the fragment data of a prescribed fragment attribute can be identified (see FIG. 6B).

According to the embodiment, regarding waveform data to be used by the waveform generator 140, as shown in FIG. 6B, the fragment IDs (1 to 4892) of all the synthesis fragments (4892) and the identifiers of the storage mediums that store the waveform data (“1” for the memory 111 and “12” for the HDD 112) are stored in association with one another.

Using the fragment IDs of synthesis fragments on an assumed path, the storage medium that stores prescribed fragment data of each synthesis fragment for use in processing in the succeeding stage of the synthesis fragment selector 130 is derived based on the data positional information 113.

According to the embodiment, it is determined whether the waveform data of synthesis fragments for use in the waveform generator 140 is stored in the memory 111 or the HDD 112. The numbers marked in the synthesis fragments (circles) in FIG. 6A indicate the identifiers of the storage mediums in which they are stored. The number “1” refers to the memory 111 and “2” refers to the HDD 112.

A condition related to obtaining fragment data from each storage medium at the time of carrying out processing to a processing unit in the succeeding stage of the synthesis fragment selector 130 and the distribution state of the prescribed fragment data of all the synthesis fragments on each of the assumed paths are compared, and assumed paths that do not fulfill the condition are thereafter excluded from evaluation.

According to the embodiment, the upper limit for the number of times to obtain waveform data from the HDD 112 in the waveform generator 140 at the time of producing synthesized speech for a processing unit (a string of synthesis units T₀ to T₄) is determined as twice. Then, as shown in FIG. 6A, the paths (bold solid lines) ((U_{SELECTED, 00}, U_{SELECTED, 11}, U_{SELECTED, 20}) (U_{SELECTED, 03}, U_{SELECTED, 14}, U_{SELECTED, 20})) that require three or more occasions of obtaining waveform data from the HDD 112 in the waveform generator 140 are selected among the paths (in broken lines and bold solid lines) connected with the synthesis fragment j=0 (U_{SELECTED, 20}) of the synthesis unit T₂, and thereafter excluded from evaluation.

In this way, the condition related to obtaining data is applied to all the assumed paths, and the paths that do not fulfill the condition will be excluded from further evaluation.

As described above, how many times each storage medium can be accessed for obtaining data in processing in the succeeding stage of the synthesis fragment selector 130 is limited and as long as the upper limit for time required for obtaining data, in other words, the data obtaining upper limit time can be controlled and reduced, the advantage of the invention is not limited by the idea of the condition or how to change it. The following approaches may be employed.

(5-3-2) Modification 1 of Method of Applying Condition

According to the embodiment, the upper limit is set as a condition. However, if the number of synthesis units included in one processing unit is fixed as described above, and two kinds of storage mediums are used, the lower limit for the number of how may times waveform data is obtained from a storage medium (for example the memory 111) that allows data to be obtained at high speed may be used as a condition and still the same advantage is provided (paths that do not fulfill the lower limit value are excluded from further evaluation).

(5-3-3) Modification 2 of Method of Applying Condition

According to the described embodiment, the access number only about the HDD 112 is set as a condition applied to the presently assumed paths as an example. However, as described above, when there are three or more storage mediums, conditions for the number of access may separately be provided for the storage mediums instead of the above described manner.

(5-3-4) Modification 3 of Method of Applying Condition

The condition provided as the number of access does not have to be applied to the presently assumed paths as it is, and for example the upper or lower limit given as the condition may be multiplied by the ratio of the sum of the duration lengths of all synthesis units and the sum of the duration lengths from the synthesis unit T₀ the present synthesis unit T₁, so that the condition may dynamically be changed for each of synthesis processing units instead of the above described manner.

(5-3-5) Modification 4 of Method of Applying Condition

According to the embodiment, a condition for a synthesis unit string related to obtaining fragment data from each storage medium is given as a constant for illustration, while a condition may externally be specified as a fixed value depending on the access speed of each storage medium in the device. Alternatively, the condition may dynamically be changed depending on the state of how each storage medium is used in other processes or the prospects for use instead of the above described manner.

(5-4) Calculation of Connection Cost

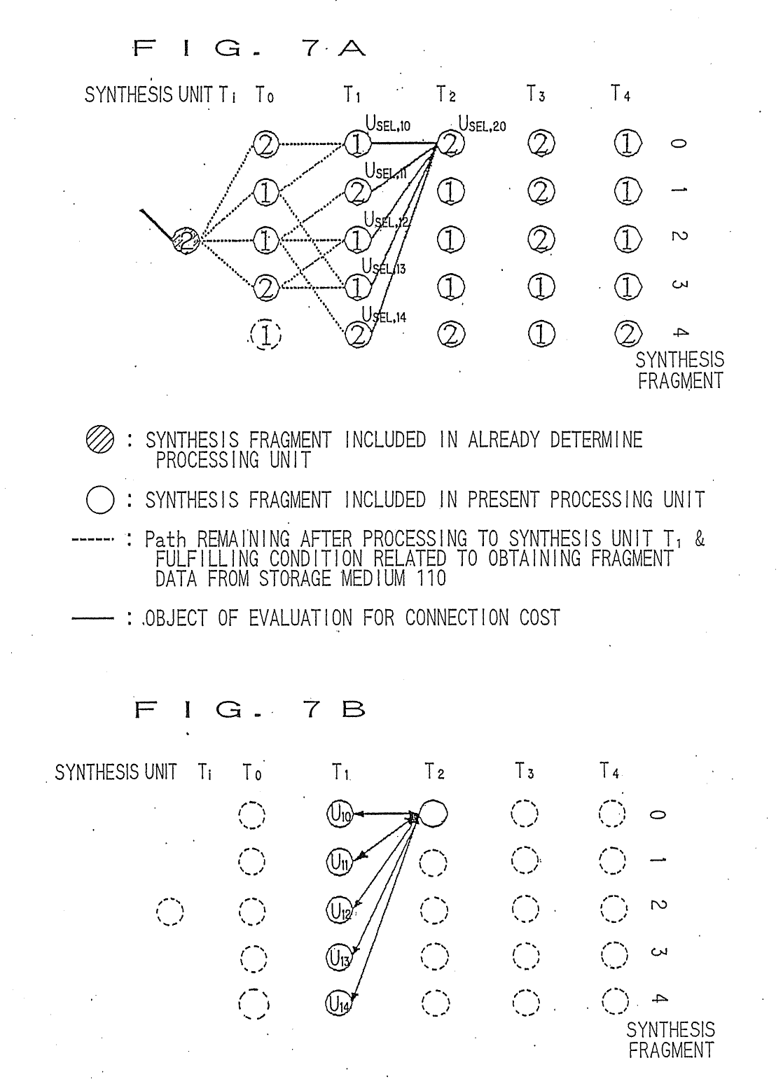

As shown in FIGS. 7A and 7B, the synthesis fragment selector 130 obtains the degree of foreignness (connection cost) DIFF_{CONC} (U_{SELECTED, (i-1)s}, U_{SELECTED, ij}) regarding the adjacent positioning of the synthesis fragment U_{SELECTED, ij} and the synthesis fragment U_{SELECTED, (i-1)s} (s=0, . . . , S−1) immediately before on the assumed path (S405).

A method of calculating the connection cost DIFF_{CONC} (U_{SELECTED, (i-1)s}, U_{SELECTED, ij}) (i=2, j=0, s=0, . . . , 4) between the synthesis fragments will be described in detail.

In prescribed M_{P} attributes P of synthesis fragments U_{SELECTED, (i-1)S}, (i−1=1, s=0, . . . , 4), and U_{SELECTED, ij} (i=2, j=0), the degree of unnatural change diff_{CONC, p} (U_{SELECTED, (i-1)s}, U_{SELECTED, ij}) of the attribute values Attrib_{P} (U_{SELECTED, (i-1)s) and Attrib}_{P} (U_{SELECTED, ij}) is calculated. The calculation is carried out using a connection sub cost function SubCost_{CONC, P} (Attrib_{P} (U_{SELECTED, (i-1)S}), Attrib_{P} (U_{SELECTED,ij})) determined for each of the attributes P.

diff_{CONC, P} (U_{SELECTED, (i-1)s}, U_{SELECTED, ij})=SubCost_{CONC, P} (Attib_{P} (U_{SELECTED, (i-1)s}), Attrib_{P} (U_{SELECTED, ij})

Based on the weighted sum (weight wₚ (p=1, . . . , Mₚ) of the unnatural change diff_{CONC, p} (U_{SELECTED, (i-1)s}, U_{SELECTED, ij}) between adjacent synthesis fragments related to these prescribed attributes, the degree of foreignness (connection cost) DIFF_{CONC}(U_{SELECTED, (i-1)s}, U_{SELECTED, ij}) regarding the adjacent positioning of the synthesis fragment U_{SELECTED, (i-j)} (i=2, j=0) and each of the synthesis fragments U_{SELECTED, (i-1)s} (i−1=1, s=0, . . . , 4) immediately before on the assumed path is calculated.

$$\begin{matrix}{DIFF}_{CONC} ( \begin{matrix}{U}_{SELECTED , ( i - 1 ) s} , \\ {U}_{SELECTED , ij}\end{matrix} ) = {\sum }_{p = 1}^{{M}_{P}} \{ \begin{matrix}{w}_{P} \times {diff}_{CONC , P} \\ ( \begin{matrix}{U}_{SELECTED , ( i - 1 ) s} , \\ {U}_{SELECTED , ij}\end{matrix} )\end{matrix} \} \\ = {\sum }_{p = 1}^{{M}_{P}} \{ \begin{matrix}{w}_{P} \times {SubCost}_{CONC , P} \\ ( \begin{matrix}{Attrib}_{P} \\ ( {U}_{SELECTED , ( i - 1 ) s} ) , \\ {Attrib}_{P} \\ ( {U}_{SELECTED , ij} )\end{matrix} )\end{matrix} \}\end{matrix} \qquad ( 2 )$$

Note that according to the embodiment, the degree of foreignness DIFF_{CONC}(U_{SELECTED, (i-1)s}, U_{SELECTED, ij}) regarding the adjacent positioning of the synthesis fragment U_{SELECTED, ij} (i=2, j=0) and each of the synthesis fragments U_{SELECTED, (i-1)s} (i−1=1, s=0, . . . , 4) immediately before on the assumed path is calculated using the weighted sum of the degree diff_{CONC,p} (U_{SELECTED, (i-1)s}, U_{SELECTED, ij}) related to each of the attributes P, while for example the degree may be calculated using the product, and the method is not limited to the described method.

(5-5) Calculation of Total Cost

The synthesis fragment selector 130 then calculates the total cost for the assumed paths (U_{SELECTED, ij}, Path, _{(i-1)sq}) (s=0, . . . , S−1, q=1, . . . , Q, S×Q in maximum) selected in S404 using the target cost DIFF_{TARGET}(Tᵢ, Uᵢⱼ) obtained in S401, the connection cost DIFF_{CONC}(U_{SELECTED, (i-1)s}, U_{SELECTED, ij}) obtained in S405, and the total evaluation (total cost) Cost (Path_{(i-1)sq}) for the Q paths (series of synthesis fragments) Path_{(i-1)sq} (q=1, . . . , Q) from synthesis units T₀ Tᵢ₋₁ stored in the synthesis fragments U_{SELECTED, (i-1)s} of the synthesis unit Tᵢ₋₁ from Expression (3) (S406).

Cost(Path_{(i-1)sq})+DIFF_{TARGET}(Tᵢ,Uᵢⱼ)+DIFF_{CONC}(U_{SELECTED,(i-1)s},U_{SELECTED ij}) (3)

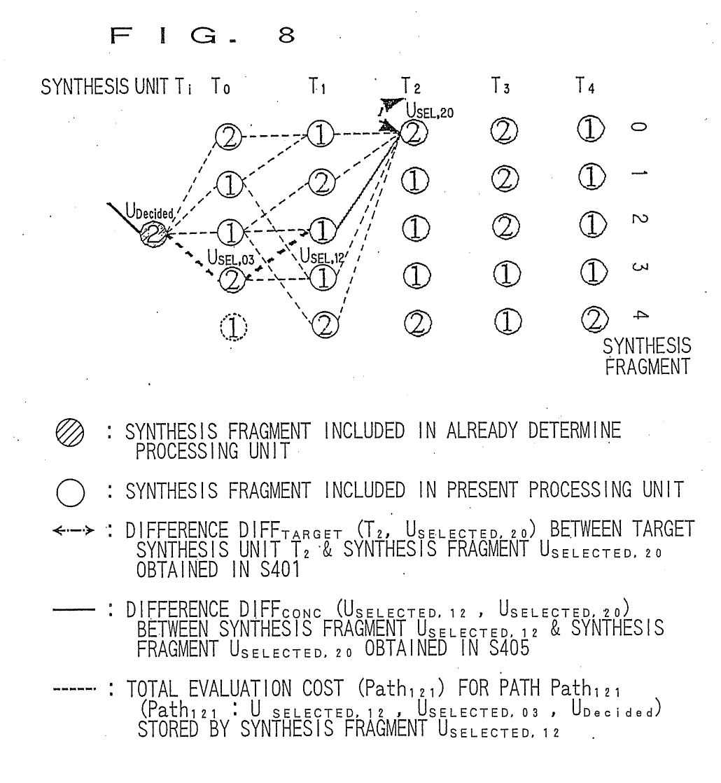

FIG. 8 is a schematic diagram showing how the total evaluation (total cost) for one of these assumed paths (U_{SELECTED, 20}, U_{SELECTED, 12} U_{SELECTED, 03}, U_{Decided}) is derived.

The diagram shows the relation between the target cost DIFF_{TARGET}(T₂, U_{SELECTED,20}) of the synthesis fragment U_{SELECTED, 20}, the connection cost DIFF_{CONC} (U_{SELECTED, 12}, U_{SELECTED, 20}) between the synthesis fragments U_{SELECTED, 20} and U_{SELECTED, 12}, and the total evaluation (total cost) Cost (Path₁₂₁) for the first path Path₁₂₁ (Path_{12q}, q=1: (U_{SELECTED, 12}, U_{SELECTED, 03}, U_{decided})) stored by the synthesis fragment U_{SELECTED, 12}.

Note that according to the embodiment, the total cost for the assumed path (U_{SELECTED, ij}, Path_{(i-1)sq}) is calculated based on the sum of the target cost DIFF_{TARGET} (Tᵢ, Uᵢⱼ) obtained in S401, the connection cost DIFF_{CONC} (U_{SELECTED, (i-1)s}, U_{SELECTED, ij}) obtained in S405, and the total cost Cost (Path_{(i-1)sq}) for the path Path_{(i-1)sq} from the synthesis units T₀ to Tᵢ₋₁ stored by the synthesis fragment U_{SELECTED, (i-1)s}, while the cost may be calculated based on the product instead of the above described method.

(5-6) Ranking

(5-6-1) General Idea of Ranking

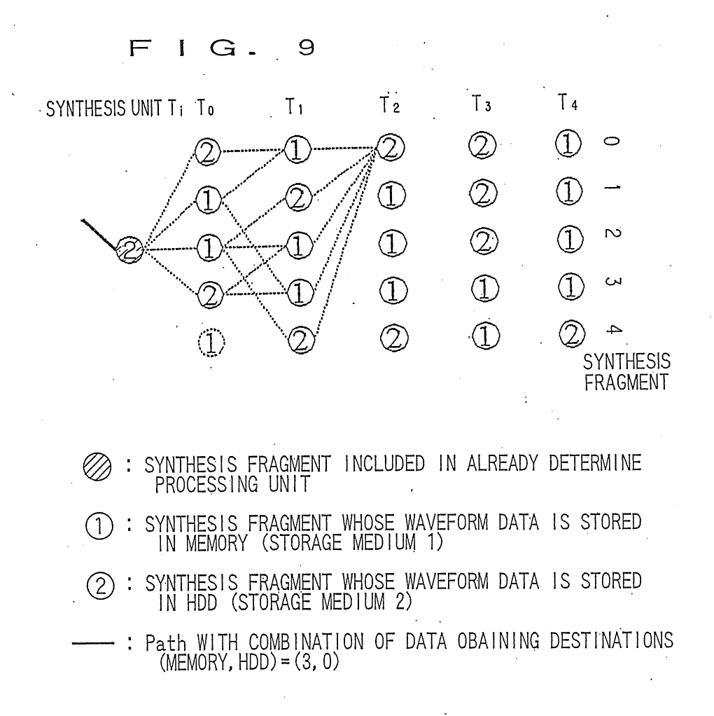

Now, as shown in FIGS. 9, 10, and 11, the synthesis fragment selector 130 determines the degree of fulfillment of the condition regarding obtaining fragment data from each of the storage mediums at the time of carrying out processing to a processing unit in the succeeding stage of the synthesis fragment selector 130 for each of the paths (S×Q in maximum) remaining after the processing in S404 and rates the results on a scale of Q ranks. Note that the “rank” refers to the number of how many times waveform data is obtained from the HDD 112.

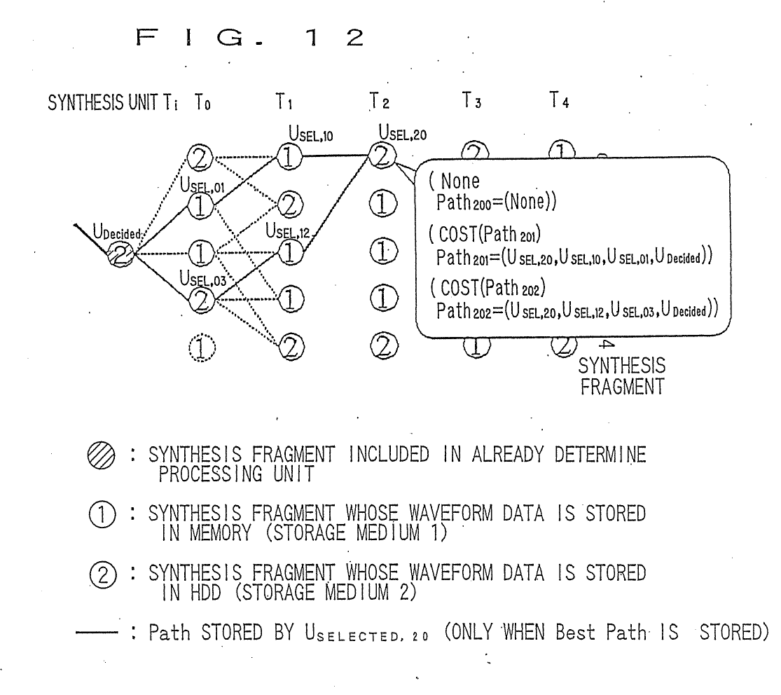

As shown in FIG. 12, one optimum path in each of the ranks having the lowest total cost derived in S406 is selected, eventually Q paths to be stored by the synthesis fragment U_{SELECTED, ij} of the synthesis unit T₁ are selected, and the path Path_{ijq} (q=1, . . . , Q) indicating a series of synthesis fragments and the total cost Cost (Path_{ijq}) of each of them are recorded, while information about the other paths is discarded altogether (S407).

(5-6-2) Degree of Fulfillment of Condition

Now, the degree of fulfillment of a condition related to obtaining data will be described in detail.

According to the embodiment, the upper limit numbers described above are ranked based on once as a unit, and the ranks of the upper limit numbers are used as an example.

In a plurality of stages of conditions more limited than the condition related obtaining data applied in S404 are provided. Conditions related to obtaining fragment data from the storage mediums at the time of carrying out processing to a processing unit (synthesis unit string) in the succeeding stage of the synthesis fragment selector 130 and the distribution state of all the storage mediums for the prescribed fragment data of all the synthesis fragments on the assumed paths are compared. Then, the assumed paths are ranked based on combinations of fulfillment/non-fulfillment of the more limited conditions.

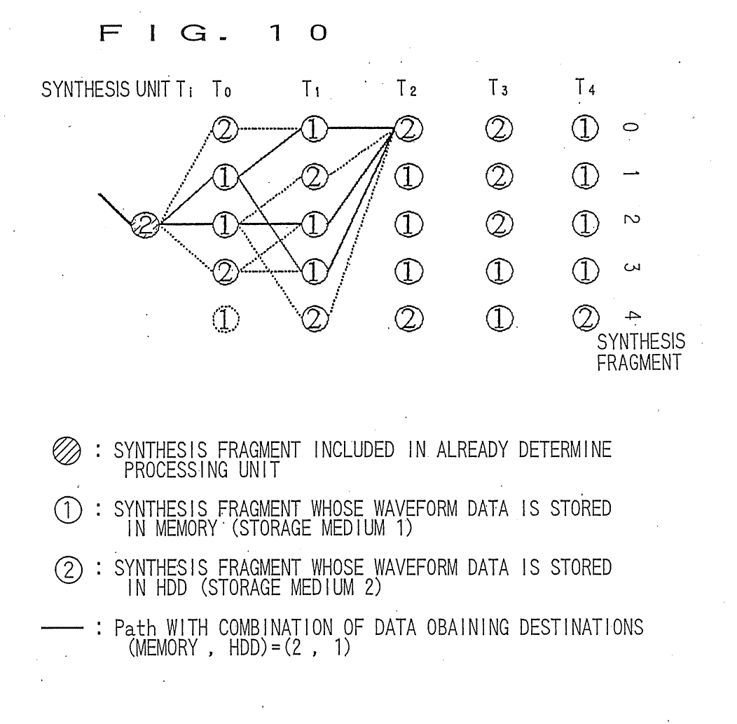

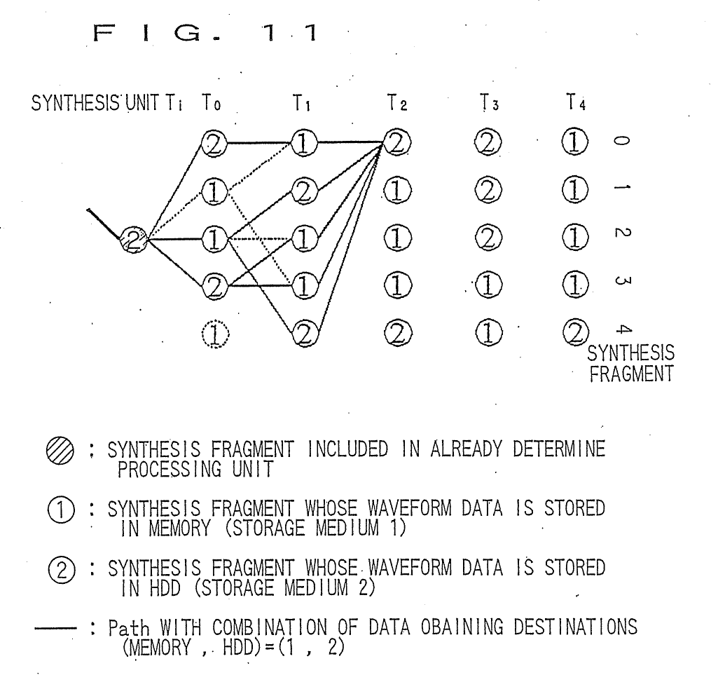

According to the embodiment, when synthesized speech is produced for a processing unit in the waveform generator 140, the number of times to obtain waveform data from the HDD 112 as a condition is reduced by one, and thus the ranks are changed. A new more limited condition that permits only once/none is provided, so that there are three ranks, i.e., the rank of a path that fulfills the condition up to none, the rank of a path that fulfills the condition up to once incremented from none, and the rank of a path that fulfills the condition up to twice incremented from once. There is no such path that fulfills the condition up to zero, i.e., the first rank (bold line) (FIG. 9), FIG. 10 shows a path in the second rank that fulfills the condition up to once incremented from none (bold solid line), and FIG. 11 shows a path in the third rank that fulfills the condition up to twice incremented from once (bold solid line).

In this way, one optimum path is selected from a group of assumed paths ranked according to the degree of fulfillment of the conditions related to obtaining data from the storage mediums, and thereafter hypotheses are developed only for these paths.

According to the embodiment, as shown in FIG. 12, the paths Path₂₀₀=(None), and Path₂₀₁=(U_{SELECTED, 20}, U_{SELECTED, 10}, U_{SELECTED, 01}, U_{Decided}) and the total cost Cost (Path₂₀₁), and the path Path₂₀₂=(U_{SELECTED, 20}, U_{SELECTED, 12}, U_{SELECTED, 03}, U_{Decided}) and the total cost Cost (Path₂₀₂) are stored in the synthesis fragment U_{SELECTED, 20} and then the succeeding processing is continued.

As described above, a better path is selected among a group of paths ranked according to the degree of fulfillment of the condition, and then the processing thereafter is continued, so that a synthesis fragment that may violate the condition in a synthesis unit after the present synthesis unit may be added to an assumed path.

(5-6-3) Modification about Degree of Fulfillment of Condition

Note that it only necessary to secure the possibility of adding a synthesis fragment that may violate the condition depending on the succeeding processing, and therefore the advantage of the invention is not limited by the method of ranking and the number of paths to select. For example, the following method may be applied.

According to the embodiment, as the method of setting a more limited condition for use in ranking the presently assumed paths, the equal interval step (once) is employed. However, the interval does not have to be equal, there may be two ranks, i.e., the rank for once and less (none and once), and the rank for twice, and the method is not limited to the above described method.

According to the embodiment, as the condition is more limited, one optimum path is selected for each rank of the degree of fulfillment, while a plurality of such paths may be selected.

As in the foregoing, instead of the condition given as time and the condition given as the number of times, the ratio of the sum of the duration lengths of all the synthesis units and the sum of the duration lengths of the synthesis unit T₀ to the present synthesis unit T₁ may be multiplied by the condition given as the time/the number of times, in other words, a method of changing the condition by dynamically relaxing it in each of the synthesis units may be employed. When the condition is dynamically relaxed, one optimum path may be selected for each of the synthesis fragments or a plurality of higher order paths may be selected.

(5-7) Conclusion

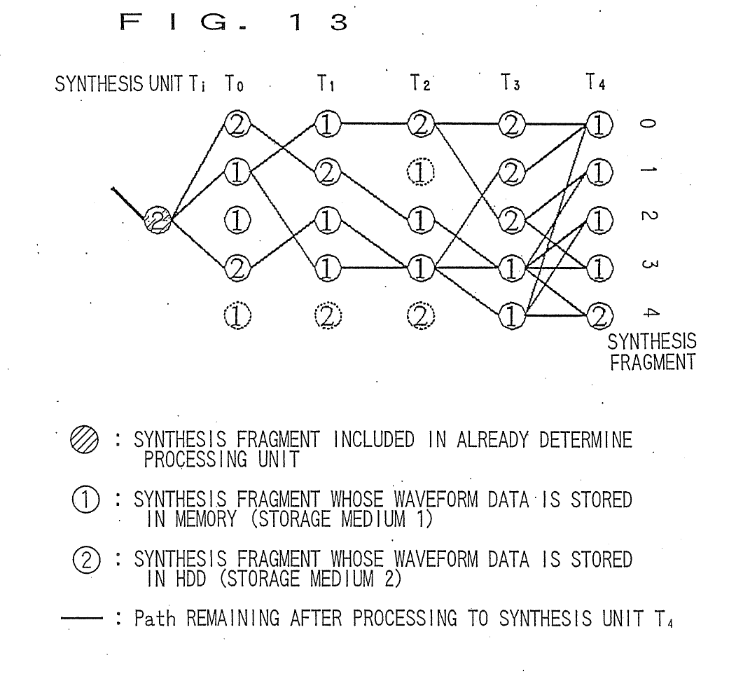

In this way, the processing from S404 to S407 is carried out to each of the synthesis fragments in the synthesis unit (S403 to S408), and the processing from S403 to S408 is carried out to each of the synthesis units in the processing unit (S402 to S409), so that as shown in FIG. 13, a plurality of paths that fulfill the condition related to obtaining data are derived for each processing unit.

(5-8) Modifications

Note that according to the embodiment, hypotheses are developed and evaluation is carried out sequentially to select a synthesis fragment string so that the condition for a synthesis unit string related to obtaining fragment data from the storage medium 110 is fulfilled.

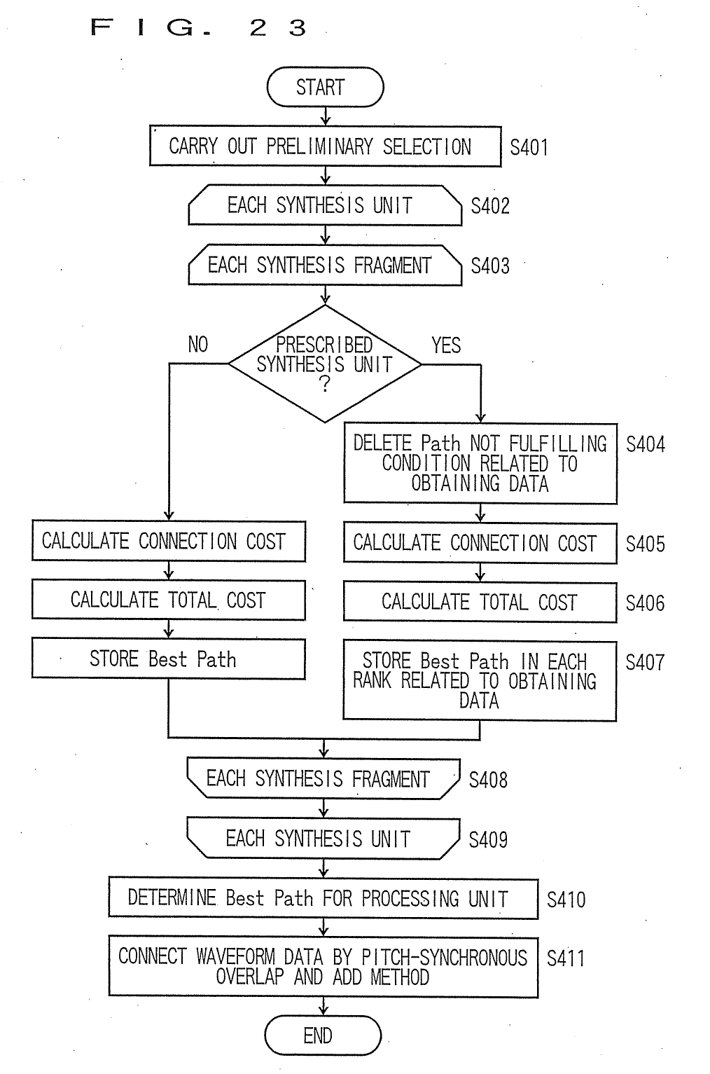

However, for example, a path may be selected in consideration of the condition related to obtaining fragment data from the storage medium 110 for every prescribed number of synthesis units, and for synthesis units in-between, a path may be selected using a conventional cost function without consideration of the condition (FIG. 23).

In an extreme case, a synthesis fragment string is selected without consideration of the condition for synthesis unit strings related to obtaining fragment data from the storage medium 110 for the first synthesis unit T₀ to the last synthesis unit Tₙ₋₁ in the processing unit, and only synthesis unit strings that fulfill the condition for the synthesis unit string related to obtaining fragment data from the storage medium 110 may be selected in the end instead of the method described above.

(5-9) Determination of Best Path

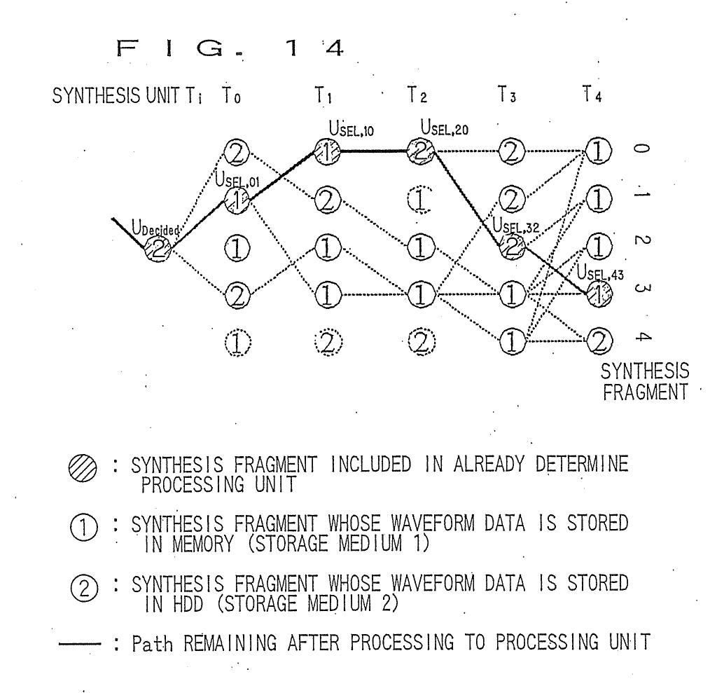

The synthesis fragment selector 130 evaluates all the paths Path_{(n-1)jq} (j=0, . . . , S−1, q=1, . . . , Q) stored by the synthesis fragments of the synthesis unit Tₙ₋₁ (=T₄) by comparing their total costs Cost(Path_{(n-1)jq}). As shown in FIG. 14, the path Path₄₃₂=(U_{SELECTED, 43}, U_{SELECTED, 32}, U_{SELECTED, 20}, U_{SELECTED, 10}, U_{SELECTED, 01}, U_{Decided}) with the lowest total cost is regarded as the optimum path in the processing unit, and a series of synthesis fragments on the path Path₄₃₂ are output (S410).

(5-10) Connecting Waveform Data

Then, the waveform generator 140 obtains waveform data or fragment data of a prescribed attribute from the storage medium 110 according to the series of synthesis fragments input from the synthesis fragment selector 130 and produces synthesized speech for the processing unit (S411).

According to the embodiment, the waveform data is obtained from the memory 111 and the HDD 112, a pitch cycle and other associated fragment data are obtained from the memory 111, and synthesized speech for the processing unit is produced by a conventional technique such as Pitch-Synchronous Overlap and Add (PSOLA) method.

(6) Advantages

As in the foregoing, with the speech synthesis apparatus 10 according to the first embodiment, a series of synthesis fragments are selected in consideration of information related to the positioning of prescribed fragment data to be used by the waveform generator 140 in the succeeding stage of the synthesis fragment selector 130 and a condition for a synthesis unit string related to data obtaining, so that the operation of obtaining waveform data for use in producing synthesized speech by the waveform generator 140 in the succeeding stage can surely be controlled.

The operation of obtaining prescribed fragment data can be prevented from being carried out too intensively from a storage medium that allows data to be obtained only at low speed, and therefore time required for producing synthesized speech for each processing unit can be prevented from being excessive. This also prevents large difference from being generated in the time required for producing synthesized speech between processing units, and surely prevents the time required for producing synthesized speech from increasing because of the data obtaining operation.

In a speech synthesis apparatus having a mechanism that produces synthesized speech sequentially from a processing unit at the beginning based on an input such as one sentence of a plurality of processing units and starts to reproduce synthesized speech produced and accumulated before the synthesized speech for all the processing units is produced, “sound discontinuity” can surely be reduced by surely reducing increase in the time required for producing synthesized speech caused by the data obtaining operation. The sound discontinuity is a state in which synthesized speech to be reproduced next has not been completely produced when synthesized speech produced and accumulated has all been reproduced.

In this way, the “sound discontinuity” caused by excessive data obtaining time is reduced, so that waveform data can be positioned regardless of the length of time required for obtaining data from a storage medium in which the waveform data is positioned. Therefore, available data increases, which improves the sound quality of synthesized speech.

### Second Embodiment

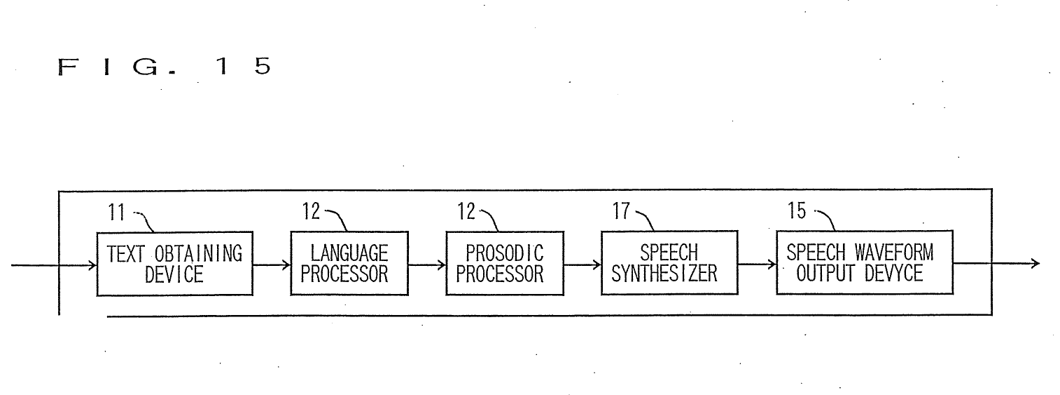

Now, a speech synthesis apparatus 16 according to a second embodiment of the invention will be described with reference to FIGS. 15 to 23.

According to the embodiment, three kinds of storage mediums (a main storing device, an auxiliary storing device, and an external storage device) are provided by way of illustration. As an example of a condition for a synthesis unit string related to obtaining data (waveform data) from any of these storage mediums, estimated time required for obtaining data is used.

(1) Configuration of Speech Synthesis Apparatus 16

FIG. 15 is a block diagram of the speech synthesis apparatus 16 according to the embodiment.

Similarly to the first embodiment described above, the speech synthesis apparatus 16 includes a text obtaining device 11 that obtains text data for speech synthesis from the outside, a language processor 12 that carries out morphological analysis/parsing to the text data, a prosodic processor 13 that outputs, to a speech synthesizer 17, a synthesis unit string based on prosodies such as accents and word classes in the text data and attributes related to the language, the speech synthesizer 17 that produces synthesized speech from the synthesis unit string, and a speech waveform output device 15 that produces a prescribed amount of output synthesized speech that is accumulated or reproduces synthesized speech sequentially as the speech is output.

The text obtaining device 11, the language processor 12, the prosodic processor 13, and the speech waveform output device 15 carry out the same kinds of processing as those of the first embodiment, and the speech synthesizer 17 carries out processing which is partly different from that of the first embodiment.

Note that synthesis units constituting a synthesis unit string delivered from the prosodic processor 13 to the speech synthesizer 17 are provided with the same kinds of information as those according to the first embodiment (such as phonological symbols, prosodic information, and language information).

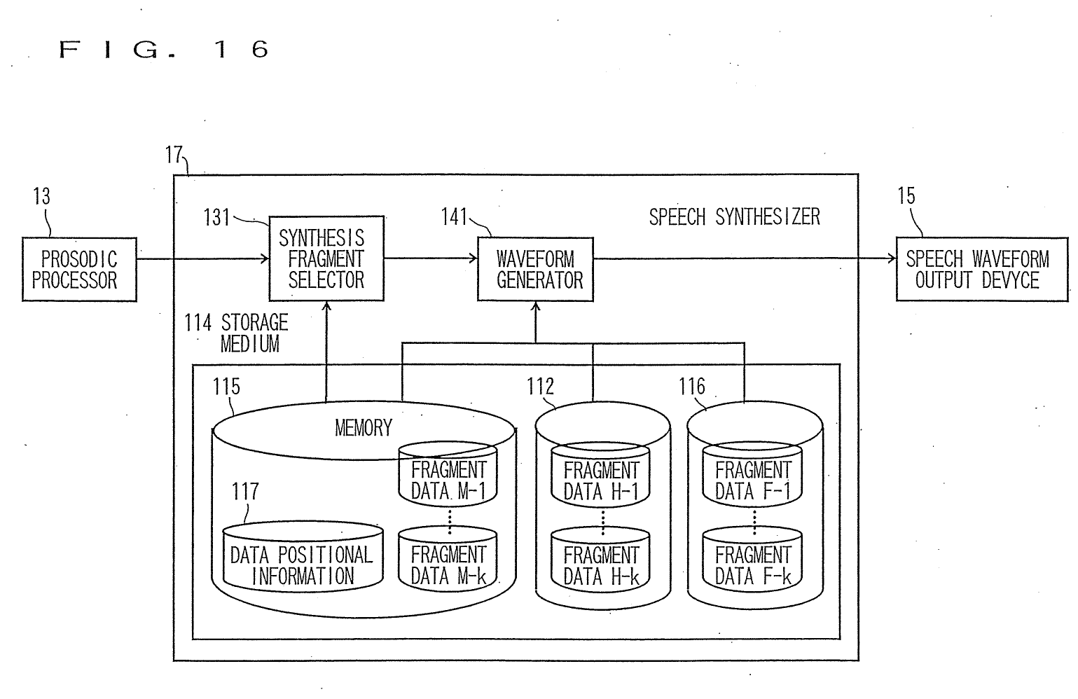

FIG. 16 is a block diagram of the speech synthesizer 17 of the speech synthesis apparatus 16 according to the second embodiment of the invention.

(2) Configuration of Speech Synthesizer 17

Unlike the first embodiment, the speech synthesizer 17 includes a NAND type flash memory 116 attached to the storage medium 114 in addition to the memory 115 and the HDD 112.

The speech synthesizer 17 includes the storage medium 114, a synthesis fragment selector 131, and a waveform generator 141.

The storage medium 114 includes a plurality of storage mediums (whose data obtaining time varies) that store all fragment data (M−1, . . . , M−k, H−1, . . . , H−k) of all synthesis fragments. More specifically, the medium includes the memory 115, the HDD 112, and the NAND type flash memory 116.

The memory 115 stores fragment data related to all the fragment attributes of all the synthesis fragments and all the waveform data of a part of the synthesis fragments, and a data positional information 117 that records which stores the waveform data of all the synthesis fragments among the memory 115, the HDD 112, and the NAND flash memory 116.

The HDD 112 and the NAND type flash memory 116 store the waveform data of synthesis fragments that are not stored in the memory 115.

The synthesis fragment selector 131 selects synthesis fragments for each synthesis unit based on the phonologic/prosodic information/language information of target synthesized speech in each synthesis unit in a synthesis unit string input from the prosodic control unit 13, the fragment data of prescribed fragment attributes of each synthesis fragment stored in the memory 115, the data positional information 117, and a condition for a synthesis unit string related to obtaining waveform data from the memory 115, the HDD 112, or the NAND type flash memory 116 and produces a synthesis fragment string as a combination of a plurality of synthesis fragments.

The waveform generator 141 obtains the waveform data of the synthesis fragments selected for each synthesis unit from the memory 115, the HDD 112, and the NAND flash memory 116, and connects the data to produce synthesized speech corresponding to the synthesis unit string.

According to the embodiment, the storage medium 114 includes the memory 115 as the main storage device, the HDD 112 as the auxiliary storage device, and the NAND type flash memory 116 as an external storage device. However, as described above, various different devices may be combined as an external storage device, while the main storing device and the external device may be used. Any kind of combination may apply instead of the example according to the embodiment as long as the medium is made of a plurality of storage mediums whose data obtaining time varies.

(3) Operation of Speech Synthesis apparatus 16

Now, the operation of the speech synthesis apparatus 16 according to the embodiment will be described essentially about the difference between the embodiment and the first embodiment.

More specifically, the operation of the speech synthesis apparatus 16 is identical to the operation of the speech synthesis apparatus 10 according to the first embodiment a shown in FIG. 3 except for S307. The operation content in S307 having the difference is identical to S404 carried out by the speech synthesizer 14 in the speech synthesis apparatus 10 according to the first embodiment as shown in FIG. 4 except for S407.

(4) Operation of Speech Synthesis apparatus 17

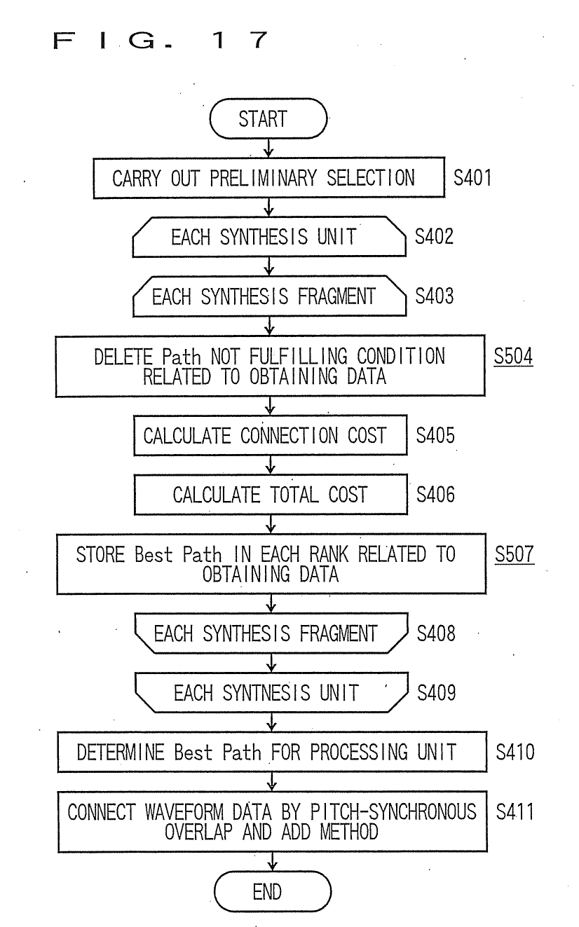

Now, with reference to FIGS. 17 to 22, S504 and S507 by the speech synthesizer 17 that are different from the operation content according to the first embodiment will be described.

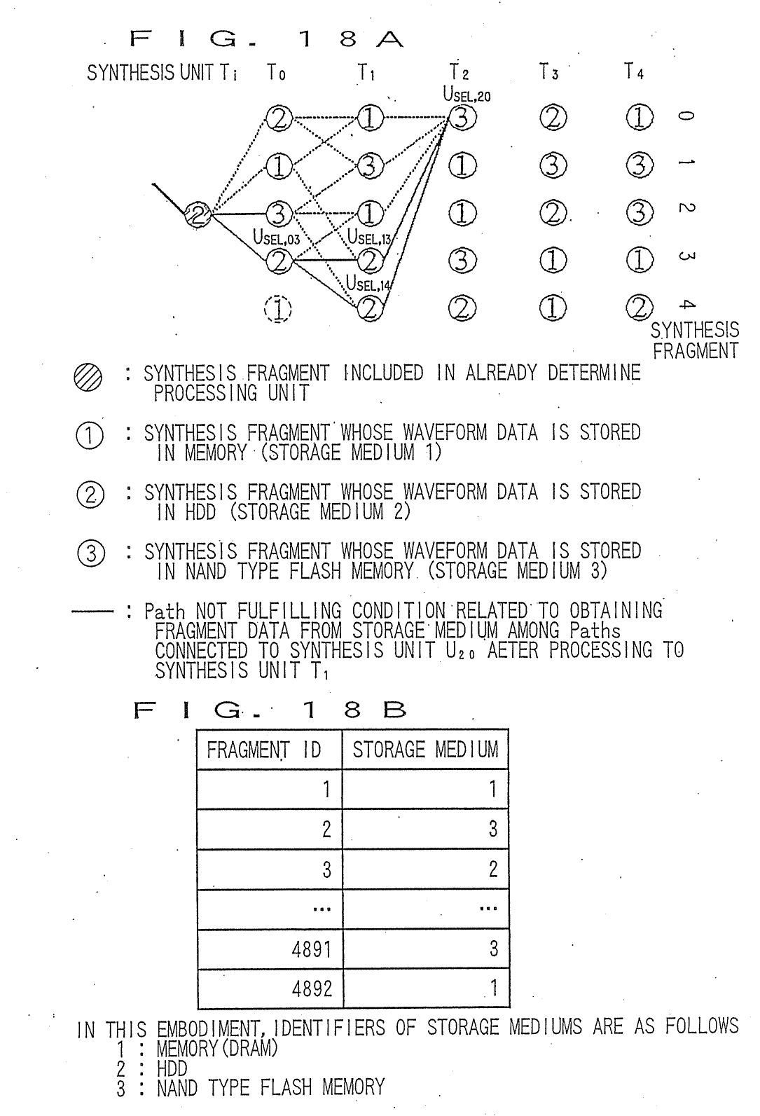

As shown in FIG. 18A, the synthesis fragment selector 131 assumes that the synthesis fragment U_{SELECTED,20} (synthesis fragment of synthesis unit T₂: j=0) succeeds all the paths (broken lines and bold solid lines) to Tᵢ and before connected to the synthesis fragments of the synthesis unit T₁ (broken lines and bold solid lines), excludes paths that do not fulfill a condition for the synthesis unit string (processing unit: T₀ to T₄) related to obtaining waveform data from the storage medium 114 from these assumed paths and excludes the paths from further evaluation (bold solid lines) (S504).

(5) Method of Applying Condition

A method of applying a condition for the synthesis unit string (processing unit) related to obtaining waveform data from the storage medium 114 according to the embodiment will be described in detail.

According to the embodiment, the upper time limit per processing unit necessary for obtaining fragment data (waveform data) for use in processing after the synthesis fragment selector 131 from the storage medium 114 is given as the condition by way of illustration.

Similarly to the first embodiment, the data positional information 117 stores waveform data for use in processing after the synthesis fragment selector 131 or the fragment ID of each synthesis fragment and the identifier of each storage medium in association with one another so that a storage medium storing fragment data of a prescribed fragment attribute can be identified.

As shown in FIG. 18B, according to the embodiment, regarding waveform data for use in the waveform generator 141, the fragments ID (1 to 4892) of all the synthesis fragments (4892) and the identifiers (“1” for the memory 115, “2” for the HDD 112, “3” for the NAND type flash memory 116) of the storage mediums that store the waveform data are stored in association with one another.

Using the fragment ID of each synthesis fragment, it is derived which storage medium stores prescribed fragment data of each synthesis fragment for use in the processing succeeding the synthesis fragment selector 131 based on the data positional information 117.

According to the embodiment, it is determined which among the memory 115, the HDD 112 and the NAND type flash memory 116 stores the waveform data of each synthesis fragment for use in the waveform generator 141. The numbers marked in synthesis fragments (circles) in FIG. 18A represent the identifiers of the storing mediums that store the fragments. The number “1” represents the memory 115, “2” represents the HDD 112, and “3” represents the NAND type flash memory.

Then, a condition related to obtaining fragment data from each storage medium at the time of carrying out processing to a processing unit in the succeeding stage of the synthesis fragment selector 131 and a result of evaluation calculated based on the distribution state of the prescribed fragment data of all the synthesis fragments in each of assumed paths in all the storage medium are compared, and assumed paths that do not fulfill the condition are excluded from further evaluation.

According to the embodiment, it is requested as a condition that time required for obtaining waveform data from the storage medium 114 for producing synthesized speech for a processing unit (a synthesis unit string of the synthesis units T₀ to T₄) in the waveform generator 141 is less than 100 msec. As shown in FIG. 18A, among the paths (broken lines and bold solid lines) connecting to the synthesis fragment U_{SELECTED, 20} of the synthesis unit T₂, paths (bold solid lines) by which time required for obtaining waveform data from the storage medium 114 in the waveform generator 141 is not less than 100 msec are selected and excluded from further evaluation.

More specifically, based on an estimated value for time required for obtaining waveform data from each storage medium and the distribution of the storage medium that stores the waveform data of all the synthesis fragments on each path derived based on the data positional information 117, in other words, the accumulated number of how many times each storage medium must be accessed thereafter, the paths fulfilling the following Expression are excluded from further evaluation.

$$100 \leq {\sum }_{( i , j ) ε {path}_{k}}^{ALL} Time ( Media ( {U}_{ij} ) )$$

where Pathₖ represents one path hypothesized to have a certain synthesis fragment as the terminal end (right end), and (i, j)εPathₖ represents a combination of synthesis fragments on the path.

The sum

$${\sum }_{( i , j ) ε {path}_{k}}^{ALL} Time ( Media ( {U}_{ij} ) )$$

of estimated values Time (Media(Uᵢⱼ) for time required for obtaining waveform data from a storage medium Media(Uᵢⱼ) that stores the waveform data of the synthesis fragments Uᵢⱼ on the path is calculated for evaluation.

For example, for the lowermost path (U_{SELECTED, 20}, U_{SELECTED, 14}, U_{SELECTED, 03}) indicated by solid line in FIG. 18A, the following holds:

$$\begin{matrix}{\sum }_{( i , j ) ε {path}_{k}}^{ALL} Time ( Media ( {U}_{ij} ) ) = Time ( Media ( {U}_{SELECTED , 03} ) ) + \\ Time ( Media ( {U}_{SELECTED , 14} ) ) + \\ Time ( Media ( {U}_{SELECTED , 20} ) ) \\ = Time ( 2 ) + Time ( 2 ) + Time ( 3 ) \\ = 50 msec + 50 msec + 0.01 msec \\ = 100.01 msec > 100 msec\end{matrix}$$

Therefore, the path is deleted. Note that information for estimated values for time required for obtaining data from each storage medium provided by the manufacturers may be used.

In this way, the condition related to obtaining data is applied to all the assumed paths, and the paths that do not fulfill the condition are excluded from further evaluation.

The condition given in the form of time as is does not have to be applied to the presently assumed paths, and for example the ratio of the sum of target duration lengths of all the synthesis units in a processing unit and the sum of target duration lengths of the synthesis units T₀ to Tᵢ may be multiplied by the time given as the condition. In this way, the condition may dynamically be increased (changed) in each synthesis unit instead of the described method.

According to the embodiment, the condition for the synthesis unit string related to obtaining the fragment data from each of the storage mediums is given as a constant by way of illustration, while the condition may externally be designated as a fixed value depending on the access speed of each of storage mediums in a device to which the invention is applied. Alternatively, the condition value may dynamically be changed depending on the state of use of each storage medium in other process or the prospects for use, and the advantage of the invention is not limited by the idea of the condition or how to change it.

(7) Storing Best Path in Each Rank

Now, S507 will be described.

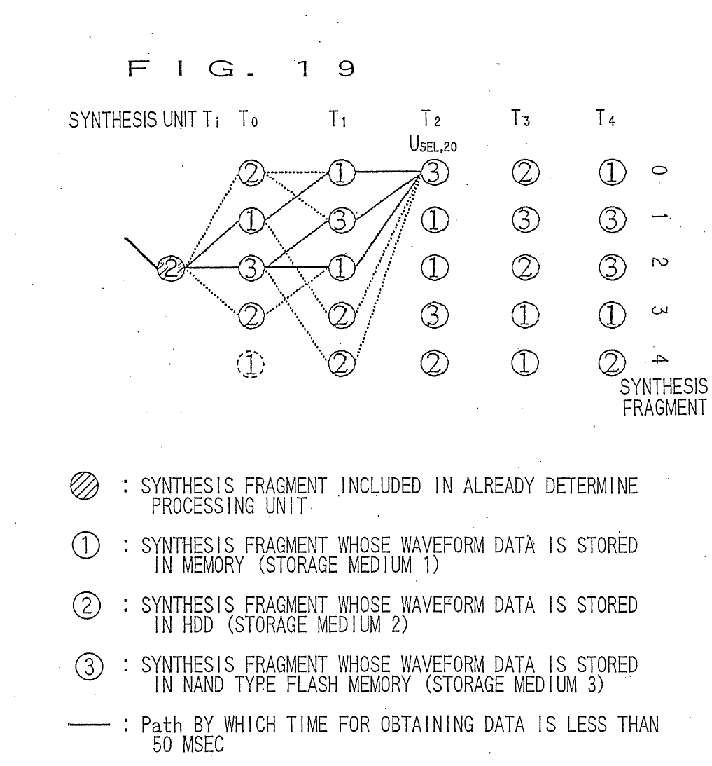

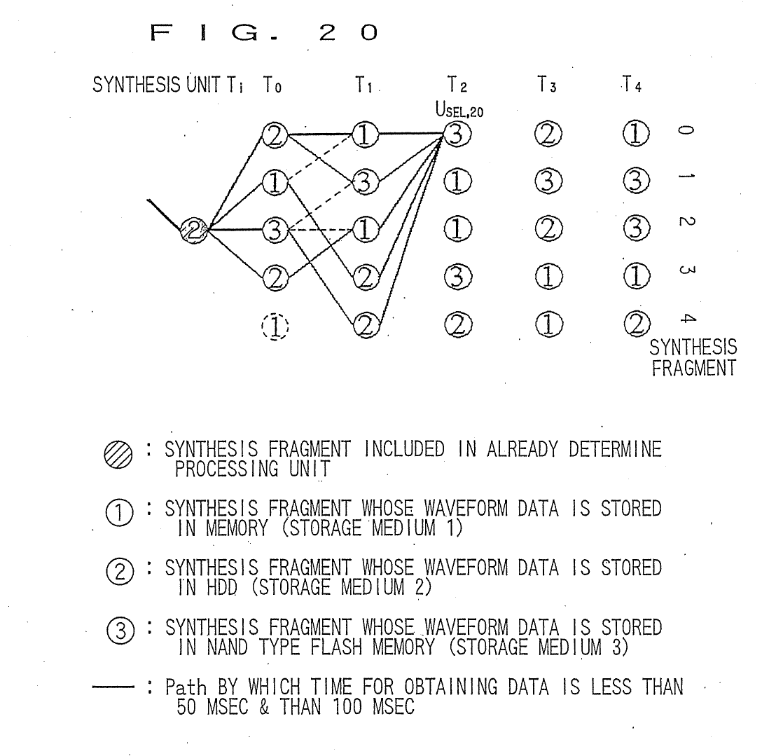

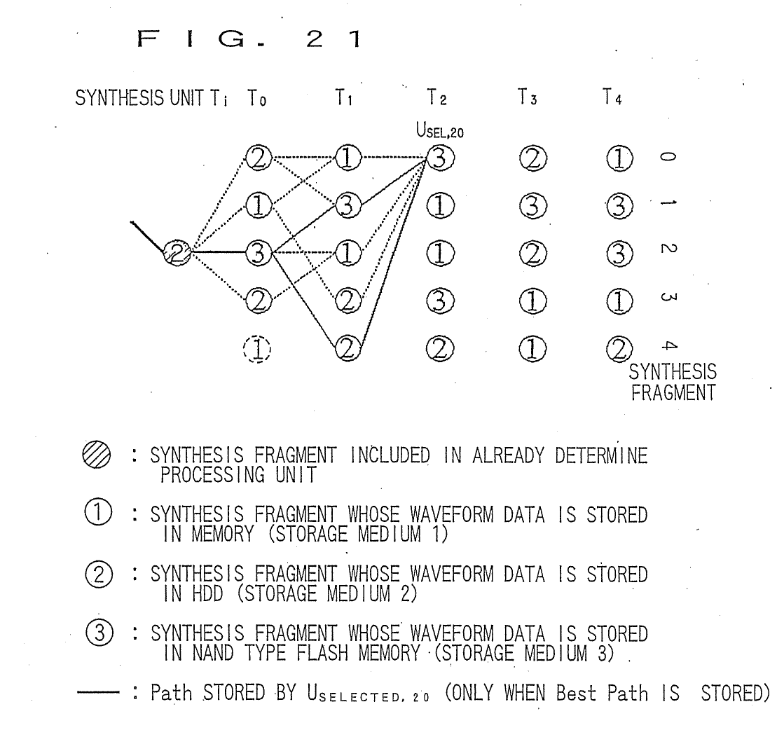

As shown in FIGS. 19 and 20, the synthesis fragment selector 131 obtains the degree of fulfillment of a condition related to obtaining fragment data from each of the storage mediums at the time of carrying out processing to a processing unit in the succeeding stage of the synthesis fragment selector 131 for each of the path remaining after the processing in S504, and rates the results on a scale of Q ranks. Then, as shown in FIG. 21, an optimum path having the lowest total cost derived in S406 in each of the ranks is selected, and Q paths to be stored by the synthesis fragment U_{SELECTED, ij} of the synthesis unit Tᵢ are eventually selected. The paths Path_{ijq} representing a series of synthesis fragments and the total cost Cost (Path_{ijq}) of each path are recorded (q=1, . . . , Q), and the information related to the other paths is discarded altogether (S507).

(8) Degree of Fulfillment of Condition

The degree of fulfillment of a condition related to obtaining data will be described in detail.

According to the embodiment, the upper limit for required time is ranked on the basis of 50 msec, and the upper limit for required time in each rank is used by way of illustration.

According to the embodiment, a plurality of levels of conditions more limited than the condition related to obtaining data used in S504 may be set, and a condition related to obtaining fragment data from each of the storage mediums at the time of carrying out processing to a synthesis unit string (processing unit) in the succeeding stage of the synthesis fragment selector 131 and an evaluation result calculated based on the distribution state of prescribed fragment data of all the synthesis fragments in all the storage mediums on each of assumed paths are compared, and the paths are ranked based on combinations of fulfillment/non-fulfillment of more limited conditions.

According to the embodiment, when synthesized speech for a processing unit is produced in the waveform generator 141, the upper limit for required time for obtaining waveform data from the storage medium 114 is decremented by 50 msec, so that less than 50 msec is set as a more limited condition, and paths are ranked into two between those fulfilling the condition of less than 50 msec, and those fulfilling the condition of less than 100 msec. FIG. 19 shows paths (bold solid lines) that fulfill the condition of less than 50 msec, and FIG. 20 shows paths (bold solid lines) that fulfill the condition of not less than 50 msec and less than 100 msec.

In this way, one optimum path is selected from each of path groups ranked depending on the degree of fulfillment of the conditions related to obtaining data from each of the storage mediums, and hypothesizing is further carried out only to the paths by the succeeding processing.

As in the foregoing, a better path is selected among path groups ranked depending on the degree of fulfillment of a condition, and the succeeding processing is continued, so that a synthesis fragment capable of violating the condition in a synthesis unit after the present synthesis unit may be added to an assumed path. In this way, it only necessary to secure the possibility of adding a synthesis fragment that may violate the condition depending on the succeeding processing, and therefore the advantage of the invention is not limited by the method of ranking and the number of paths to select. For example, the following method may be applied.

According to the embodiment, as a method of setting a more limited condition for use in raking the presently assumed paths, the equal interval step (50 msec) is employed. However, the interval does not have to be equal, and the interval may divided into three ranks corresponding to the range of less than 25 msec, the range of not less than 25 msec and less than 50 msec, and the range of not less than 50 msec and less than 100 msec instead of the described method.

According to the embodiment, one optimum path for each rank of degree of fulfillment is selected by further limiting the condition, while a plurality of such paths may be selected.

Instead of the condition given as time as described above, the ratio of the sum of the duration lengths of all the synthesis units and the sum of the duration lengths of the synthesis unit T₀ to the present synthesis unit T₁ may be multiplied by the condition given as the time/the number of times, in other words, a method of changing the condition by dynamically relaxing it in each of the synthesis units may be employed. When the condition is dynamically relaxed, one optimum path may be selected for each synthesis fragment or a plurality of higher order paths may be selected.

(9) Deriving Paths that Fulfill Condition

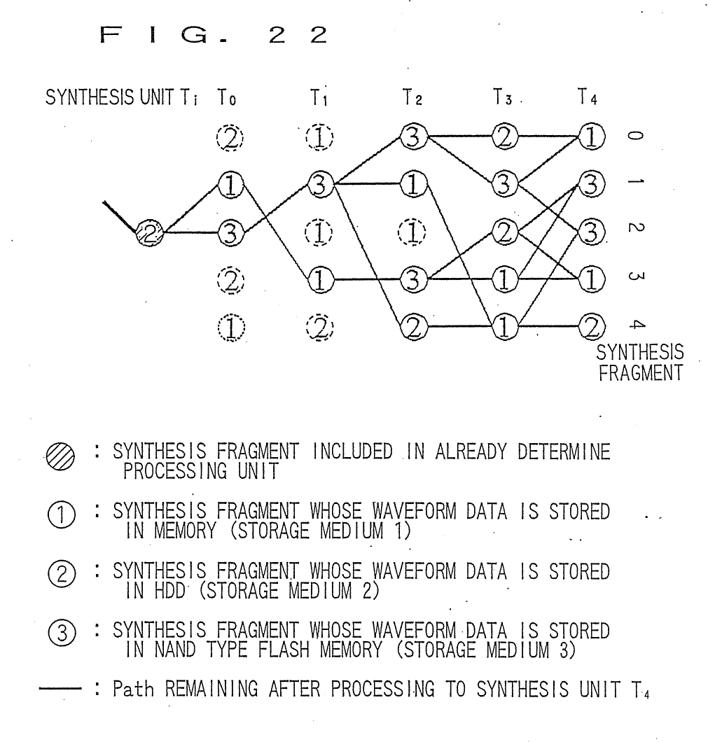

In this way, the processing in S504, S405, S406, and S507 is carried out to each synthesis fragment in the synthesis unit (S403 to S408), the processing in S403 to S408 is carried out to each synthesis unit in the processing unit (S402 to S409), and as shown in FIG. 22, a plurality of paths that fulfill the condition related to obtaining data are derived for one processing unit.

(10) Advantages

As described above, in the speech synthesis apparatus 16 according to the second embodiment, a synthesis fragment string is selected in consideration of information related to the position of prescribed fragment data for use in the waveform generator 141 in the succeeding stage of the synthesis fragment selector 131 and a condition for a synthesis unit string related to obtaining data, so that the operation of obtaining waveform data for use in producing synthesized speech by the waveform generator 141 in the succeeding stage can surely be controlled. In this way, the operation of obtaining prescribed fragment data can be prevented from being carried out too intensively from a storage medium that allows data to be obtained only at low speed, and therefore the time required for producing synthesized speech for each processing unit can be prevented from being excessive. This can surely prevent the time required for producing synthesized speech from increasing because of the data obtaining operation.

Modifications

Note that the invention is not limited by the described embodiments but can be embodied by modifying elements without departing from the scope when it is reduced to practice.

For example, the time required for obtaining data may be changed depending on the structure and performance of devices used to carry out the invention and the environment in which they are used. However, the “sound discontinuity” caused by excessive data obtaining time can be reduced depending on the devices used by allowing a condition related to obtaining waveform data from a storage medium that stores waveform data to be externally designated, so that the sound quality adapted to the devices can be implemented. Furthermore, in a speech synthesis apparatus that produces/accumulates synthesized speech corresponding to all the processing units and then starts to reproduce it, high quality synthesized speech may be produced anytime.

Various inventions may be formed by combining a plurality of elements disclosed by the embodiments as required. For example, several elements may be omitted from all the elements of the described embodiments. Elements touched upon in different embodiments may be combined as desired.

1. A speech synthesis apparatus that obtains waveform data of synthesis fragments corresponding to a plurality of synthesis units in a prescribed processing unit included in an input synthesis unit string and synthesizes speech by connecting the waveform data, comprising:
an attribute information storage medium that stores the attribute information of said synthesis fragments other than the waveform data;
a plurality of waveform data storage mediums that store waveform data of said synthesis fragments, time required for obtaining said stored waveform data from said waveform data storage mediums being different among one another;
a data positional information storage medium that stores data positional information including the identifier of a waveform data storage medium that stores said waveform data for each said synthesis fragment;
a candidate obtaining device configured to obtain a synthesis fragment candidate corresponding to each said synthesis unit from said attribute information storage medium based on the attribute information of each said synthesis unit in said processing unit;
a synthesis fragment selector configured to obtain a plurality of series each including a combination of a plurality of synthesis fragment candidates obtained for each said synthesis unit and selects one series from said plurality of series based on said data positional information so that the total time required for obtaining the waveform data of said synthesis fragments in said processing unit does not exceed the upper limit for data obtaining time; and
a synthesis fragment generator configured to combine synthesis fragments on said selected one series to generate a synthesis fragment string; and
a waveform generator configured to obtain the waveform data of the synthesis fragments included in said synthesis fragment string from each said waveform data storage medium and connects the waveform data.

2. The apparatus according to claim 1, wherein said upper limit for data obtaining time is converted to the number of how many times data is obtained from each said waveform storage medium.

3. The apparatus according to claim 1, wherein said upper limit for data obtaining time is converted to access time to each said waveform data storage medium.

4. The apparatus according to claim 1, wherein said upper limit for data obtaining time can be changed.

5. The apparatus according to claim 1, wherein when said synthesis fragment selector selects one series among said plurality of series based on said data positional information so that said upper limit for data obtaining time is not exceeded,
said synthesis fragment selector selects a plurality of series that do not allow said upper limit for data obtaining time to be exceeded, ranks said data strings based on ranks produced by dividing the upper limit for data obtaining time stepwise, selects a series having a low cost in each said rank, and selects a plurality of series having a lower cost from a set of said series having low costs.

6. The apparatus according to claim 1, wherein said synthesis fragment selector selects a series with the lowest cost among said plurality of series that do not allow said upper limit for data obtaining time to be exceeded.

7. The apparatus according to claim 1, wherein said attribute storage medium and the data positional information storage medium are both a memory.

8. The apparatus according to claim 1, wherein said waveform data storage medium is one of a memory, a hard disk, and a flash memory.

9. A method of synthesizing speech by obtaining waveform data of synthesis fragments corresponding to a plurality of synthesis units within a prescribed processing unit included in an input synthesis unit string from a plurality of waveform data storage mediums, time for obtaining data from said waveform data storage mediums being different among one another, and synthesizing speech by connecting the data, said method comprising:
obtaining synthesis fragment candidates corresponding to each said synthesis unit based on the attribute information of each said synthesis unit in said processing unit from attribute information storage mediums that store the attribute information of said synthesis fragments other than the waveform data;
obtaining a plurality of series made of combinations of a plurality of synthesis fragment candidates obtained for each said synthesis unit and selecting one series among said plurality of series based on data positional information including the identifier of a waveform data storage medium that stores the waveform data so that the total time for obtaining the waveform data of each said synthesis fragment in said processing unit does not exceed the upper limit for data obtaining time;
combining synthesis fragments on said one selected series, thereby producing a synthesis fragment string; and
obtaining the waveform data of the synthesis fragments included in said synthesis fragment string from each said waveform data storage medium, thereby connecting the waveform data.

10. A speech synthesis program product that enables a computer to obtain waveform data of synthesis fragments corresponding to a plurality of synthesis units in a prescribed processing unit included in an input synthesis unit string from a plurality of waveform data storage mediums from which time for obtaining data is different among one another, and synthesize speech by connecting the waveform data, said program product comprising the instructions of:
obtaining synthesis fragment candidates corresponding to each said synthesis unit based on the attribute information of each said synthesis unit in said processing unit from attribute information storage mediums that store the attribute information of said synthesis fragments other than the waveform data;
obtaining a plurality of series made of combinations of a plurality of synthesis fragment candidates obtained for each said synthesis unit, thereby selecting one series among said plurality of series based on the data positional information including the identifier of a waveform data storing medium that stores said waveform data so that the total time for obtaining the waveform data of each said synthesis fragment in said processing unit does not exceed the upper limit for data obtaining time;
producing a synthesis fragment string by combining synthesis fragments on said selected one series; and
obtaining the waveform data of synthesis fragments included in said synthesis fragment string from each said waveform storage medium and connecting the data.
